(19) United States
(12) Patent Application Publication
(10) Pub. No.: US 2025/0055087 A1
(43) Pub. Date: Feb. 13, 2025

(54) SECONDARY BATTERY AND ELECTRONIC DEVICE

(71) Applicant: SEMICONDUCTOR ENERGY LABORATORY CO., LTD., Atsugi-shi, Kanagawa-ken (JP)

(72) Inventors: Kazutaka KURIKI, Ebina, Kanagawa (JP); Seiya SAITO, Atsugi, Kanagawa (JP); Teruaki OCHIAI, Atsugi, Kanagawa (JP); Kengo AKIMOTO, Isehara, Kanagawa (JP)

(21) Appl. No.: 18/724,035

(22) PCT Filed: Dec. 16, 2022
(86) PCT No.: PCT/IB2022/062346

§ 371 Date: Jun. 25, 2024

(30) Foreign Application Priority Data
Dec. 29, 2021 (JP) 2021-215434

(51) Int. Cl. H01M 50/136; H01G 11/28; H01G 11/50; H01M 4/02; H01M 4/04; H01M 4/38; H01M 4/525; H01M 50/105

(52) U.S. Cl. CPC H01M 50/136; H01M 4/0426; H01M 4/382; H01M 4/525; H01M 50/105; H01G 11/28; H01G 11/50; H01M 2004/021

(57) ABSTRACT

The relative position shifts of a positive electrode and a negative electrode occur owing to bending in charge or discharge, whereby uneven distribution is caused and potential varies. Not graphite but a lithium metal film is used as the negative electrode. A lithium metal film is formed over one side of the negative electrode current collector by an evaporation method or a sputtering method, and a laminated body is formed such that surfaces of two negative electrode current collectors where no film is formed are in contact with each other.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a secondary battery, an electronic device including a secondary battery, and a vehicle including a secondary battery.

Another embodiment of the present invention relates to a power storage system including a secondary battery and a battery control circuit. Another embodiment of the present invention relates to an electronic device and a vehicle each including a power storage system.

Note that in this specification, a power storage device refers to all elements and devices having a function of storing power. Examples of the power storage device include a storage battery (also referred to as a secondary battery) such as a lithium-ion secondary battery, a lithium-ion capacitor, and an electric double layer capacitor.

In addition, an electronic device in this specification refers to all devices including power storage devices, and electro-optical devices including power storage devices, information terminal devices including power storage devices, and the like are all electronic devices.

### BACKGROUND ART

In recent years, a variety of power storage devices typified by lithium-ion secondary batteries, lithium-ion capacitors, or air batteries have been actively developed. In particular, demand for lithium-ion secondary batteries with high output and high energy density has rapidly grown with the development of semiconductor industry, for portable information terminals typified by mobile phones, smartphones, tablets, or laptop computers, portable music players, digital cameras, medical equipment, and next-generation clean energy vehicles (e.g., hybrid vehicles (HVs), electric vehicles (EVs), and plug-in hybrid vehicles (PHVs)), for example. The lithium-ion secondary batteries are essential as rechargeable energy supply sources for today's information society.

Patent Document 1 discloses a bendable secondary battery.

### REFERENCE

### Patent Document

[Patent Document 1] Japanese Published Patent Application No. 2015-130650

### SUMMARY OF THE INVENTION

### Problems to be Solved by the Invention

Electronic devices carried around by users or electronic devices worn by users have been actively developed.

Electronic devices carried around by users or electronic devices worn by users operate using primary batteries or secondary batteries, which are examples of a power storage device, as power sources. Electronic devices carried around by users are desired to be used for a long time; thus, a high-capacity secondary battery can be used. Since high-capacity secondary batteries are large in size, there is a problem in that their incorporation in electronic devices increases the weight and the volume of the electronic devices. In view of the problem, development of small or thin high-capacity secondary batteries that can be incorporated in portable electronic devices is being promoted.

Some electronic devices that are carried around can be folded to be reduced in size. In most cases, the foldable electronic devices are provided with a plurality of housings, with a folding region typified by a hinge portion as a boundary.

In a conventional manner, a secondary battery cannot be placed in a folding region typified by a hinge portion; thus, when a foldable electronic device and a non-foldable electronic device are compared, they differ in the capacity of a secondary battery that can be incorporated even if they are the same in size. In a conventional foldable device that can be folded in two, a non-bendable secondary battery is provided in one housing or a plurality of non-bendable secondary batteries are separately provided in a plurality of housings, with a folding region as a boundary. In the case where only one non-bendable secondary battery is provided in one housing, increasing capacity is difficult. In addition, in the case where a plurality of non-bendable secondary batteries are separately provided in a plurality of housings, the number of components increases; for example, in the case where a control circuit for controlling balance between a plurality of secondary batteries, or a connection circuit is to be provided, size reduction is difficult.

Therefore, an object is to provide a bendable secondary battery suitable for an electronic device that is foldable or bendable.

An object of one embodiment of the present invention is to provide a lithium-ion secondary battery having excellent charge and discharge cycle performance and a fabrication method thereof. Another object of one embodiment of the present invention is to provide a highly safe or reliable secondary battery and a fabrication method thereof.

Note that the description of these objects does not preclude the existence of other objects. In one embodiment of the present invention, there is no need to achieve all of these objects. Other objects can be derived from the description of the specification, the drawings, and the claims.

### Means for Solving the Problems

A user of a foldable electronic device may charge a secondary battery with the electronic device in a folded state and may discharge the secondary battery with the electronic device in an opened state. Therefore, under the assumption that a foldable electronic device is equipped with a bendable secondary battery, a secondary battery that can be charged at least in a bent state is provided.

In order to provide a bendable battery, an embossed exterior film is used so that laminated bodies slide past each other inside the battery. It is preferable that single-side-coated current collectors be used and laminated so that uncoated surfaces come into contact with each other, in which case the laminated bodies are more likely to slide when being bent.

In order to provide a repeatedly bendable battery, sheet-like current collectors are configured to slide; thus, there is a problem in that the whole electrodes are displaced each other, and the relative position between a positive electrode active material and a negative electrode active material is shifted.

FIG. 17A is a simple schematic cross-sectional view of part of the structure of a secondary battery 110. FIG. 17A is a schematic cross-sectional view of a laminated secondary battery, and a laminated body 112 of an electrode 143 is stored in an exterior body 111. FIG. 17A illustrates the secondary battery 110, which includes graphite in a negative electrode active material, a double-side-coated negative electrode current collector, and a double-side-coated positive electrode current collector. In the case where graphite is used as the negative electrode active material, lithium ions are inserted or extracted during charge and discharge, and thus stress is changed. One of the problems, caused by shifting of the position of a positive electrode active material layer 118a and a negative electrode active material layer 119a, is described with reference to FIG. 17B. As illustrated in FIG. 17B, the negative electrode is designed to have a large area than the positive electrode at the point of fabrication. FIG. 17B illustrates an example in which a double-side-coated current collector is used. For simplicity, positive electrode active material particles in a positive electrode active material layer 118b and graphite particles in a negative electrode active material layer 119b are not illustrated in the drawing. In a lithium-ion secondary battery, lithium ions are considered to move straight between a positive electrode and a negative electrode in charge and discharge as indicated by arrows in FIG. 17C. Note that a separator 65 is provided between a double-side-coated negative electrode current collector 166 and a double-side-coated positive electrode current collector 164.

FIG. 17B is a schematic cross-sectional view of a conventional secondary battery. With the use of a negative electrode active material typified by graphite, lithium ions are released and move straight to a positive electrode active material having a layered structure. When the secondary battery 110 is bent, the whole electrode slides and the sliding interface is formed between the separator 65 and the positive electrode (the positive electrode active material layer 118a in the drawing). The sliding interface is sometimes formed between the separator 65 and the negative electrode (the negative electrode active material layer 119a). When the secondary battery 110 using a double-side-coated current collector is bent, a positive electrode slides, and at the portion where the positive electrode slides, released lithium ions do not move to the original position (a position where lithium ions had released from graphite), or move to different positions. More specific model diagrams are shown in FIG. 17C and FIG. 17D. FIG. 17C shows the corresponding positions to which lithium ions move in charge before the sliding. FIG. 17D shows correspondence of the position to which lithium ions move in discharge after the sliding. Lithium ions ideally move straight at the shortest distance between the position where the positive electrode exists and the position where the negative electrode exists in both charge and discharge. As shown in FIG. 17C, a lithium ion moves from a positive electrode active material 1(P1) to a negative electrode active material 1(N1), a lithium ion moves from a positive electrode active material 2(P2) to a negative electrode active material 2(N2), and a lithium ion moves from a positive electrode active material 3(P3) to a negative electrode active material 3(N3). However, the positions of the positive electrode and the negative electrode shift owing to bending in charge or bending in discharge, and unevenness of the amount of insertion or extraction of lithium ions is caused, whereby potential varies. For example, as shown in FIG. 17D, in the case where the relative position between the positive electrode active material and the negative electrode active material slides due to bending, a lithium ion moves from the negative electrode active material 1(N1) to the positive electrode active material 2(P2), a lithium ion moves from the negative electrode active material 2(N2) to the positive electrode active material 3(P3), and a lithium ion moves from the negative electrode active material 3(N3) to a positive electrode active material 4(P4), so that any lithium ions may not move to the positive electrode 1.

In order to solve these problems, a lithium metal film is used as negative electrode instead of graphite. When the lithium metal film is used as the negative electrode, variations in potentials do not occur because the potential of the negative electrode (a potential at which lithium ions are occluded) is always the vicinity of 0 V. In addition, in the case where the lithium metal film is used as the negative electrode, even when the amount of occluded lithium in charge varies, the originally resided lithium is released in discharge, so that charge and discharge can be performed stably. In addition, the potential difference between the positive electrode and the negative electrode increases by approximately 0.1 V as compared to the secondary battery using graphite, so that the energy density increases.

In the case of the secondary battery using graphite for the negative electrode, charge and discharge are performed by insertion and extraction of lithium ions to/from graphite layers; by contrast, lithium metal is deposited when the lithium metal film is used as the negative electrode. When the lithium metal film is used as the negative electrode, there is a large amount of lithium ions; and thus, the amount of lithium ions inserted to the positive electrode active material tends to be uniform in discharge. Therefore, in the case where the lithium metal film is used, potential variation hardly occurs even when a current collector slides due to bending in charge or discharge. In the case where graphite is used, stress is generated and volume expansion occurs in insertion and extraction of lithium ions; thus, deterioration proceeds. On the other hand, in the case where the lithium metal film is used as a negative electrode, the deposition occurs and less stress is generated.

A lithium metal film is formed over one surface of the negative electrode current collector by an evaporation method or a sputtering method, and surfaces not provided with lithium metal films of two negative electrode current collectors are come close to each other to form a laminated body.

A separator is preferably provided between the positive electrode and the negative electrode so as to prevent a short circuit between the positive electrode and the negative electrode.

The structure of the invention disclosed in this specification is a secondary battery in which a laminated body including a positive electrode current collector, a separator, and a negative electrode current collector is surrounded by an exterior body. The secondary battery includes a bent portion capable of being bent. A negative electrode active material layer is provided over the negative electrode current collector. The negative electrode active material layer includes a lithium film. In order to improve reliability, the bendable portion of the secondary battery is preferably small so that the secondary battery is partially bent, rather than entirely bent. Note that the number of bent portions is not limited to one, and a plurality of bent portions may be provided. The secondary battery is made to be bent only at the specific part (the bent portion) with the use of the housing or the hinge portion, so as to provide a smaller number of bendable portions.

The thickness of the lithium film that is the negative electrode active material layer is in the range of 100 nm to 10 μm. Furthermore, since a conductive additive and a binder are not used in a negative electrode, the negative electrode can be thinner than that in the case where graphite is used. In the case where the graphite is used for the negative electrode and the negative electrode active material layer is formed using the conductive additive and the binder, the lithium film is formed to have a thickness of approximately 100 μm over one surface of the current collector.

In each of the above structures, the negative electrode active material layer is a lithium metal thin film formed by an evaporation method or a sputtering method.

In each of the above structures, the laminated body includes a first negative electrode current collector and a second negative electrode current collector in contact with the first negative electrode current collector. The first negative electrode current collector and the second negative electrode current collector are overlapped with each other and partly fixed by ultrasonic bonding, and the fixed part is also overlapped with and fixed to part of a lead electrode, and they are electrically connected.

In each of the above structures, the positive electrode active material used for the positive electrode active material layer is not particularly limited. The material for the positive electrode active material is not limited to a lithium composite oxide represented by LiMₓO_{y} (x>0 and y>0, more specifically, y=2 and 0.8<x<1.2, for example) typified by lithium cobalt oxide. One embodiment of the present invention can also be applied to an NiCo based material represented by LiNiₓCo₁₋ₓO₂ (0<x<1), lithium composite oxide represented by as a lithium composite oxide represented by LiMₓO_{y} (an NiMn-based material represented by LiNiₓMn₁₋ₓO2 (0<x<1), for example), or the like. One embodiment of the present invention can also be applied to an NiCoMn-based (also referred to as NCM) material represented by LiNiₓCo_{y}Mn_{z}O₂ (x>0, y>0, 0.8<x+y+z<1.2). Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

Since NCM has a large irreversible capacity, using a lithium film for the negative electrode is useful as compared with the case where the graphite is used for the negative electrode.

One embodiment of the present invention can also be applied to a lithium composite oxide with a layered rock-salt crystal structure, for example, Li₂MnO₃, Li₂MnO₃—LiMeO₂ (Me represents Co, Ni, or Mn) and the like.

### Effect of the Invention

One embodiment of the present invention can provide an optimum secondary battery for a foldable electronic device.

Note that the description of these effects does not preclude the existence of other effects. Note that one embodiment of the present invention does not need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A is a structure example of a secondary battery that is bent. FIG. 1B is a partially enlarged model diagram of the secondary battery that is bent. FIG. 1C is a plan view of the secondary battery.

FIG. 2A is a structure example of a secondary battery before being bent, FIG. 2B is a partially enlarged model diagram of a secondary battery including a current collector on both surfaces of which lithium films are deposited.

FIG. 3A is a structure example of a secondary battery before being bent. FIG. 3B is a structure example of a secondary battery after being bent. FIG. 3C is a model diagram of a secondary battery in a bent state.

FIG. 4 is a cross-sectional structure illustrating part of a laminated body that is connected to a lead electrode 13a on a negative electrode side.

FIG. 5 is a cross-sectional structure illustrating part of a laminated body that is connected to a lead electrode 13b on a positive electrode side.

FIG. 6A to FIG. 6D are diagrams showing methods for forming a positive electrode active material.

FIG. 7 is a diagram showing a method for forming a positive electrode active material.

FIG. 8A to FIG. 8C are diagrams showing methods for forming a positive electrode active material.

FIG. 9 is a diagram illustrating an example of a flow for forming a positive electrode active material.

FIG. 10 is a cross-sectional view illustrating a reaction vessel.

FIG. 11A and FIG. 11B are diagrams illustrating a method for processing a film.

FIG. 12A to FIG. 12D are diagrams illustrating a method for forming a secondary battery.

FIG. 13A is an example of a perspective view of an electronic device. FIG. 13B is a schematic view illustrating part of a cross section of an electronic device.

FIG. 14A is an example of a perspective view of an electronic device. FIG. 14B is a schematic view illustrating part of a cross section of an electronic device.

FIG. 15A is an external view illustrating an example of an electronic device showing one embodiment of the present invention. FIG. 15B is an external view seen from another direction.

FIG. 15C is a diagram illustrating an example of the appearance of a secondary battery incorporated in an electronic device.

FIG. 16A and FIG. 16B are diagrams illustrating an example of a device for space.

FIG. 17A is a comparison structure example of a secondary battery using graphite as a negative electrode active material. FIG. 17B is a partially enlarged comparison model diagram of a bent secondary battery using graphite as a negative electrode active material. FIG. 17C and FIG. 17D are model diagrams showing a detailed correspondence.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification, crystal planes and orientations are indicated by the Miller index. In the crystallography, a bar is placed over a number in the expression of crystal planes and orientations; however, in this specification, because of application format limitations, crystal planes and orientations may be expressed by placing − (a minus sign) at the front of a number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification, segregation refers to a phenomenon in which in a solid made of a plurality of elements (e.g., A, B, and C), a certain element (e.g., B) is spatially non-uniformly distributed.

In this specification, a surface portion of a particle of an active material refers to a region from a surface to a depth of approximately 10 nm. A plane generated by a fissure (or a crack) can be considered as a surface. A region at a position deeper than the surface portion is referred to as an inner portion.

In this specification, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification, a rock-salt crystal structure refers to a structure in which cations and anions are alternately arranged. Note that a cation or anion vacancy may be included.

In this specification, an O3′ type crystal structure (also referred to as a pseudo-spinel crystal structure) of a composite oxide containing lithium and a transition metal refers to a crystal structure with a space group R-3m, which is not a spinel crystal structure but a crystal structure in which an ion of cobalt or magnesium is coordinated to six oxygen atoms and the cation arrangement has symmetry similar to that of the spinel crystal structure. Note that in the O3′ type crystal structure, a light element (lithium) occupies a site coordinated to four oxygen atoms in some cases. Also in that case, the ion arrangement has symmetry similar to that of the spinel crystal structure.

The O3′ type crystal structure can be regarded as a crystal structure that contains Li between layers randomly but is similar to a CdCl₂ crystal structure. The crystal structure similar to the CdCl₂ type crystal structure is close to a crystal structure of lithium nickel oxide (Li_{0.06}NiO₂) that is charged until the charge depth reaches 0.94; however, pure lithium cobalt oxide or a layered rock-salt positive electrode active material containing a large amount of cobalt is known not to have such a crystal structure generally.

Anions of a layered rock-salt crystal and anions of a rock-salt crystal form a cubic close-packed structure (face-centered cubic lattice structure). Anions of an O3′ type crystal are also presumed to form a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

In this specification, the positive electrode active material of one embodiment of the present invention is expressed as a positive electrode material or a secondary battery positive electrode material in some cases. In this specification, the positive electrode active material of one embodiment of the present invention preferably includes a compound. In this specification, the positive electrode active material of one embodiment of the present invention preferably includes a composition. In this specification, the positive electrode active material of one embodiment of the present invention preferably includes a composite.

### Embodiment 1

In this embodiment, an example of a secondary battery of one embodiment of the present invention will be described.

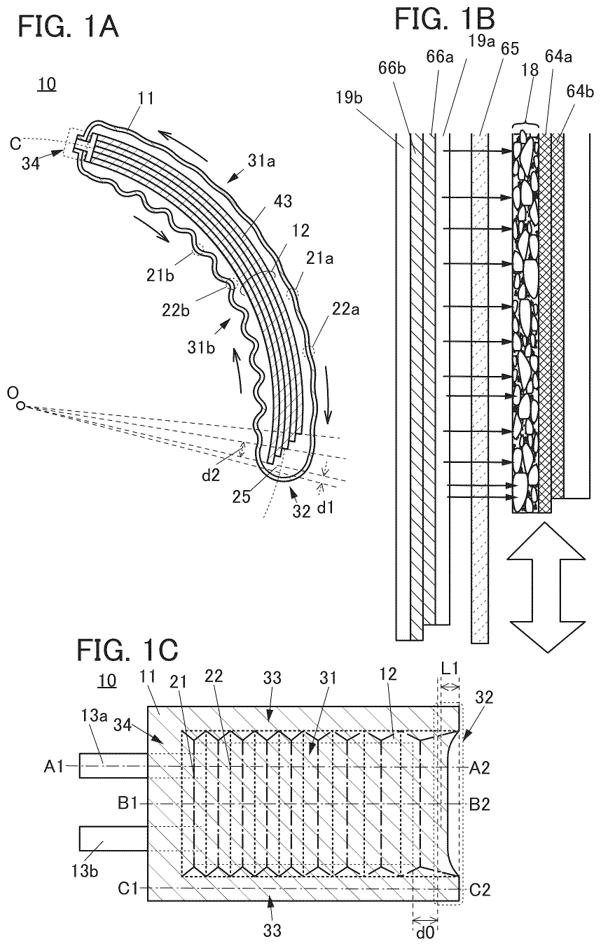

FIG. 1A is a schematic cross-sectional view of the secondary battery 10 in a bent state, and FIG. 1B is a partially enlarged model diagram of an end portion of a laminated body 12 of the secondary battery 10 that is bent. FIG. 1C is a plan view of the secondary battery 10 before being bent.

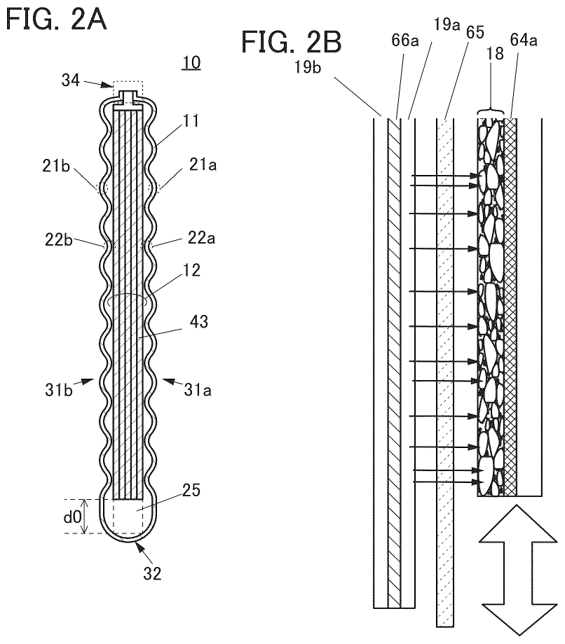

FIG. 2A is a schematic cross-sectional view of the secondary battery 10 before being bent. As illustrated in FIG. 2A, in the exterior body 11, a space 25 (also referred to as a gap or a hollow) is provided between an end portion of the laminated body 12 that is on a folding portion 32 side and an interior surface of the exterior body 11 that is located on the folding portion 32 side. Here, as illustrated in FIG. 2(A), the length of the space 25 in the direction parallel to the extending direction of a bonding portion 33 (the direction from a junction portion 34 toward the folding portion 32) is represented as the distance d0. The distance d0 can also be referred to as the distance between the end portion of the laminated body 12 that is on the folding portion 32 side and the interior surface of the exterior body 11 that is located on the folding portion 32 side.

FIG. 1A is a schematic cross-sectional view of the secondary battery 10 in the state of being bent in an arc shape with a point O at the center. Here, the secondary battery 10 is bent such that a portion 31a faces outward and a portion 31b faces inward. The exterior body 11 has a film-like shape and is bent in two so as to sandwich the laminated body 12. The laminated body 12 includes at least a plurality of electrodes 43.

As illustrated in FIG. 1A, the portion 31a positioned on the outer side changes its form such that the wave amplitude becomes smaller and the wave period becomes larger. In a cross-sectional view, the wave can also be referred to as a groove. That is, the distance between crest lines 21a and the distance between trough lines 22a of the portion 31a that is on the outer side increase. By contrast, the portion 31b that is positioned on the inner side changes its form such that the wave amplitude becomes larger and the wave period becomes shorter. That is, the distance between crest lines 21b and the distance between trough lines 22b of the portion 31b that is on the inner side decrease after bending. In such a manner, the portion 31a and the portion 31b change their forms, whereby stress applied to the exterior body 11 is relieved, and the secondary battery 10 can be bent without any damage to the exterior body 11.

As illustrated in FIG. 1A, the laminated body 12 changes its form such that the positions of the plurality of electrodes 43 are shifted relatively. This relieves stress applied to the laminated body 12, allowing the secondary battery 10 to be bent without any damage to the laminated body 12. When the thickness of the electrode 43 is set sufficiently small with respect to the curvature radius with which the secondary battery 10 is bent, less stress is applied to the electrodes 43 themselves.

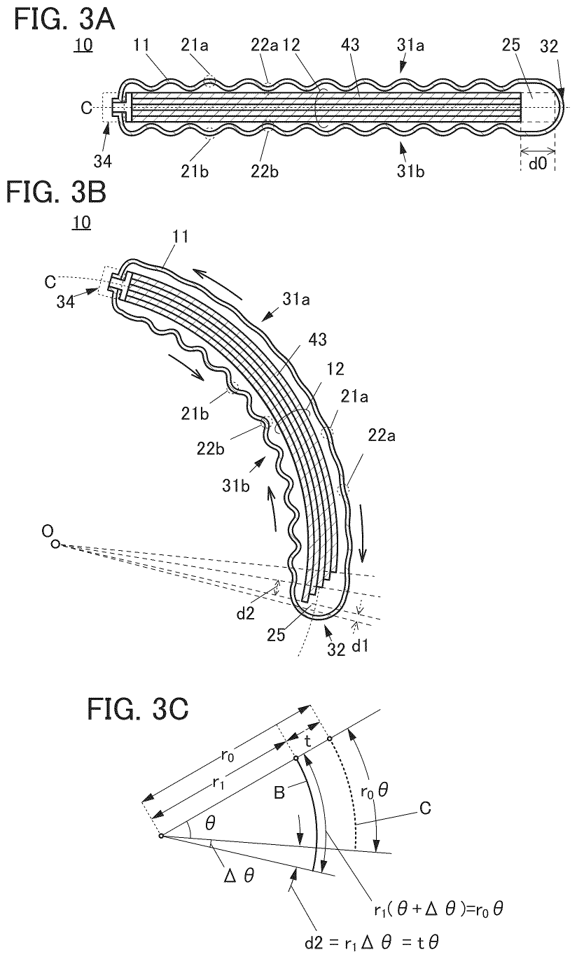

Neutral plane C and curvature radius are described with reference to FIG. 3A, FIG. 3B, and FIG. 3C. In FIG. 3A, the neutral plane of the secondary battery 10 is illustrated as a neutral plane C. Note that FIG. 3A is the same as FIG. 2A except for the direction. Here, the neutral plane C corresponds to the neutral plane of the electrode 43 that is located in the middle of the plurality of electrodes 43 included in the laminated body 12. In FIG. 3B, a neutral plane is a curved surface because the secondary battery 10 is bent. Among the electrodes 43 included in the laminated body 12, the electrodes 43 that are located outward from the neutral plane C shift to the bonding portion 34 side when the secondary battery 10 is bent.

The secondary battery 10 illustrated in FIG. 3A is brought into the state illustrated in FIG. 3B when being bent, and the end portion of the electrode 43 located inward from the neutral plane C shifts to the folding portion 32 side. Note that FIG. 3B is the same as FIG. 1A. Here, the distance between the interior surface of the exterior body 11 and the end portion of the innermost electrode 43 on the folding portion 32 side decreases from the distance d0 to a distance d1. Here, the amount of relative deviation between the electrode 43 including the neutral plane aligned with the neutral plane C and the innermost electrode 43 is assumed to be a distance d2. The distance d1 is equal to a value obtained by subtracting the distance d2 from the distance d0.

In the case where the distance d0 before bending is smaller than the distance d2 that is the amount of relative deviation after bending, the electrodes 43 of the laminated body 12 that are located inward from the neutral plane C come into contact with the interior surface of the exterior body 11. Thus, a required value of the distance d0 will be described below.

Description will be given below with reference to FIG. 3C. In FIG. 3C, a curve corresponding to the neutral plane C is shown by a dashed line, and a curve corresponding to the innermost surface of the laminated body 12 is shown as a curve B by a solid line.

A curve C is the arc with a radius r₀, and a curve B is the arc with a radius r₁. The difference between the radius r₀ and the radius r₁ is assumed to be t. Here, t corresponds to half of the thickness of the laminated body 12. The arc lengths of the curve C and the curve B are equal to each other. The arc angle of the curve C is assumed to be θ, and the arc angle of the curve B is assumed to be θ+Δθ.

The distance d2, which is the amount of deviation between an end portion of the curve C and the curve B, is calculated from the above relation as follows.

$$\begin{matrix}d 2 = {r}_{1} \times Δθ \\ = t \times θ\end{matrix} \qquad [ Formula 1 ]$$

This indicates that the distance d2 can be estimated from the thickness of the laminated body 12 and the bending angle and does not depend on the length of the laminated body 12 and the bending curvature radius.

Setting the distance d0 of the space 25 larger than or equal to the distance d2 as described above can prevent the laminated body 12 and the exterior body 11 from coming in contact with each other when the secondary battery 10 is bent. Thus, in the case where the secondary battery 10 including the laminated body 12 with a thickness of 2t is used while being bent with the maximum angle set to θ, the distance d0 between the laminated body 12 and the interior surface of the exterior body 11 in the space 25 is set to a value greater than or equal to t×θ.

For example, when the battery is used while being bent at 30°, the distance d0 of the space 25 is set to a value greater than or equal to πt/6. Similarly, when the battery is used while being bent at 60°, the distance d0 is set to a value greater than or equal to η/3; when the battery is used while being bent at 90°, the distance d0 is set to a value greater than or equal to πt/2; and when the battery is used while being bent at 180°, the distance d0 is set to a value greater than or equal to πt. Note that π is the circular constant.

For example, in the case where the secondary battery 10 is not used in the state of being wound, the maximum bending angle of the secondary battery 10 is estimated to be 180°. Thus, when the secondary battery 10 is used in such a manner, the distance d0 is set to a value larger than or equal to πt, preferably larger than πt, whereby the secondary battery 10 can be used for all devices. In the case where the secondary battery 10 is used while being bent in two, for example, the secondary battery 10 can be incorporated into a variety of electronic devices in which the secondary battery 10 is used while being bent to have a V shape or a U shape.

In the case where the secondary battery 10 is wound so as to circle around a cylindrical object once, for example, the distance d0 of the space 25 is set to a value larger than or equal to 2πt so that the secondary battery 10 can be bent at 360°. In the case where the secondary battery 10 is wound so as to circle around a cylindrical object more than once, the distance d0 of the space 25 is set to an appropriate value accordingly. In the case where the secondary battery 10 is changed in form to have a bellows shape, the distance d0 of the space 25 is set to an appropriate value depending on the direction, the angle, and the number of bent portions of the secondary battery 10.

FIG. 1B is a partially enlarged model diagram of the end portion of the laminated body 12 in the secondary battery 10 that is bent, and it shows a state in which the laminated body 12 slides in the direction indicated by a white arrow when the secondary battery 10 is bent or stretched. In FIG. 1B, for easy understanding, a space is illustrated between the separator 65 and a negative electrode active material layer 19a, but actually, the separator 65 and the negative electrode active material layer 19a are in contact with each other. A space is illustrated between the separator 65 and a positive electrode active material layer 18, but actually, the separator 65 and the positive electrode active material layer 18 are in contact with each other.

As illustrated in FIG. 1B, a lithium metal thin film formed by an evaporation method or a sputtering method is used as the negative electrode active material layer 19a of a negative electrode current collector 66a. FIG. 1B illustrates a state where the negative electrode current collector 66b adjacent to the positive electrode current collector 66a is also provided with a negative electrode active material layer 19b, the negative electrode current collector 66a and the negative electrode current collector 66b slide, the separator 65 and the positive electrode active material layer 18 slide, and a positive electrode current collector 64a and a positive electrode current collector 64b slide.

In FIG. 1C, the secondary battery 10 includes an exterior body 11, a laminated body 12 held in the exterior body 11, and a lead electrode 13a and a lead electrode 13b that are electrically connected to the laminated body 12 and extend to the outside of the exterior body 11. In addition to the laminated body 12, an electrolyte is enclosed in the exterior body 11.

In FIG. 1C, the exterior body 11 includes a pair of portions 31 between which the laminated body is sandwiched, a folding portion 32, a pair of bonding portions 33, and a bonding portion 34. The pair of bonding portions 33 is belt-like portions extending in the direction substantially perpendicular to the folding portion 32 and is provided on both sides of the portion 31. The bonding portion 34 is a belt-like portion overlapping with the lead electrode 13a and the lead electrode 13b. The portion 31 can also be referred to as a region surrounded by the folding portion 32, the pair of bonding portions 33, and the bonding portion 34. Here, FIG. 1A illustrates an example in which the lead electrode 13a and the lead electrode 13b are partly sandwiched between the bonding portion 34.

In FIG. 1C, at least a surface of the portion 31 of the exterior body 11 has a corrugated shape in which projections and depressions are repeated in the direction in which the pair of bonding portions 33 extends. In other words, the portion 31 has a corrugated shape in which crest lines 21 and trough lines 22 are alternately repeated. In FIG. 1C, the crest lines 21 connecting top portions of the projections are shown by dashed-dotted lines, and the trough lines 22 connecting bottom portions of the troughs are shown by dashed lines.

In the exterior body 11 illustrated in FIG. 1C, which is a plan view, the length of the bonding portion 33 in the extension direction is longer than the length of the region parallel to the extension direction of the bonding portion 33, which passes through the bonding portion 34, the portion 31, and the folding portion 32. As illustrated in FIG. 1C, a portion of the folding portion 32 that is located on to the bonding portion 34 side is closer to the bonding portion 34 by a distance L1 from a line connecting end portions of the pair of bonding portions 33 on the folding portion 32 side.

FIG. 2B is a schematic cross-sectional view of the bent secondary battery 10 including a current collector on both surfaces of which lithium films are deposited. Since FIG. 2B is different from FIG. 1B only in the structure of the laminated body 12, the common portions are denoted by the same reference numerals as those in FIG. 1. Unlike in FIG. 1B, both surfaces of the positive electrode current collector 64a are coated, that is, one surface side of the positive electrode current collector 64a is provided with the positive electrode active material layer 18, and the other surface side of the positive electrode current collector 64a is also provided with the positive electrode active material layer 18. In addition, lithium films are evaporated on both surfaces of the negative electrode current collector 66a; that is, the negative electrode active material layer 19a and the negative electrode active material layer 19b are provided. When the secondary battery 10 is bent as illustrated in FIG. 2B, the negative electrode active material layer 19a and the separator 65 or the positive electrode active material layer 18 and the separator 65 slide.

In FIG. 2B, a lithium metal thin film formed by an evaporation method or a sputtering method is used as the negative electrode active material layer. Even in the case where a lithium metal thin film is provided on each of the surfaces, or even in the case where the relative position of the positive electrode or the negative electrode shift due to bending during charge or discharge, variation in potential is suppressed.

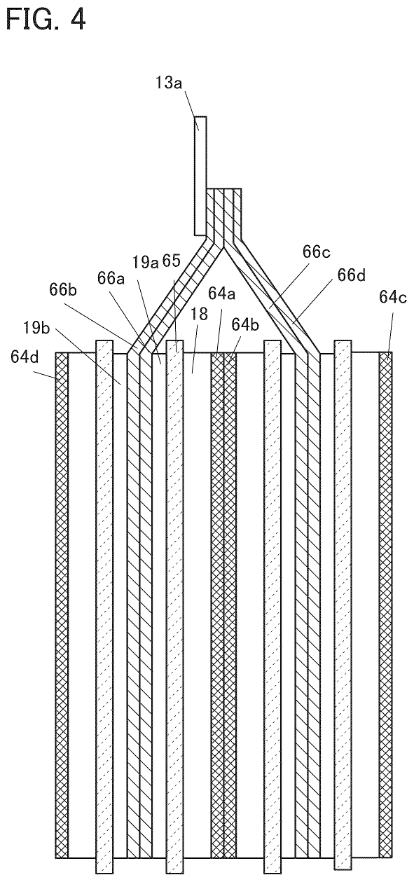

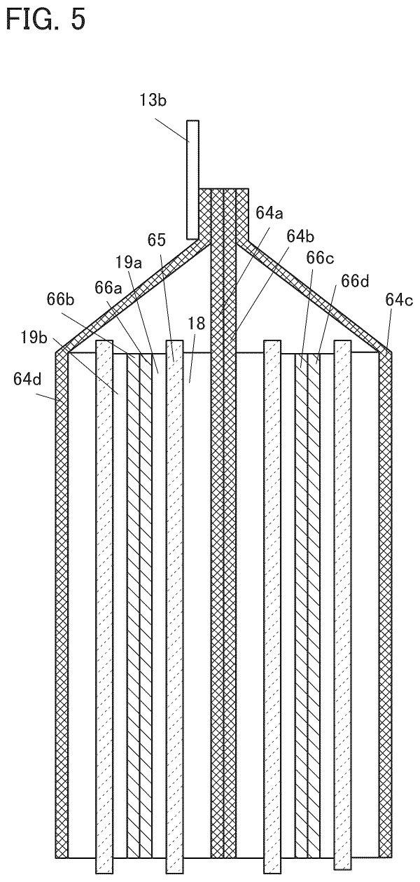

The laminated body 12 at least has a structure where positive electrodes and negative electrodes are alternately laminated. The laminated body 12 can also be called an electrode stack. Separators may be provided between each of the positive electrodes and each of the negative electrodes. Here, as the number of layers in the laminated body 12 increases, the capacity of the secondary battery 10 can increase. In FIG. 1B and FIG. 2B, part of the laminated body 12 is selectively illustrated for description, and the whole laminated body 12 is not illustrated. The details of the laminated body 12 will be described later with reference to FIG. 4 and FIG. 5.

Here, the thickness of the laminated body 12 is 123 μm, which is the total thickness of 15 μm of the positive electrode current collector, 80 μm of the positive electrode active material layer, 20 μm of the separator, 8 μm of the negative electrode current collector, and 100 nm of the lithium film, for example. When the number of stacks is two, the thickness of the laminated body 12 is 246 μm. Therefore, the thickness of the laminated body 12 is, for example, larger than or equal to 200 μm and smaller than or equal to 9 mm, preferably larger than or equal to 400 μm and smaller than or equal to 3 mm, further preferably larger than or equal to 500 μm and smaller than or equal to 2 mm, and is typically approximately 1.5 mm.

FIG. 4 illustrates part of the laminated body 12 in FIG. 1A, and is part of a cross sectional view taken along the dashed line A1-A2 in FIG. 1C. Note that in FIG. 4, components that are the same as those in FIG. 1B are denoted by the same reference numerals as in FIG. 1B. In FIG. 4, four negative electrode current collectors 66a, 66b, 66c, and 66d are used. In FIG. 4, the lead electrode 13a and the negative electrode current collectors 66a, 66b, 66c, and 66d are fixed by ultrasonic bonding.

FIG. 5 illustrates another part of the laminated body 12, and there are four positive electrode current collectors (64a, 64b, 64c, and 64d). In FIG. 5, the lead electrode 13b and the positive electrode current collectors 64a, 64b, 64c, and 64d are fixed by ultrasonic bonding.

As illustrated in FIG. 4 and FIG. 5, when the secondary battery is bent, positions of portions fixed by the lead electrode 13a or the lead electrode 13b hardly shift. When the secondary battery is bent, the relative positions of the positive electrode current collectors 64a, 64b, 64c, and 64d shift.

### [Fabricating Method Example]

An example of a method for fabricating the secondary battery 10 will be described below. First, a method for fabricating a negative electrode that can be applied to the secondary battery 10 will be described.

A lithium metal film is formed over a current collector used as the negative electrode by an evaporation method or a sputtering method. For the current collector, a metal such as gold, platinum, aluminum, titanium, copper, magnesium, iron, cobalt, nickel, zinc, germanium, indium, silver, or palladium or an alloy thereof can be used.

The lithium metal film can be formed over the current collector using a metal mask. A conductive film may be patterned by being selectively removed by dry etching using a resist mask or the like. Since the lithium metal film reacts with oxygen, nitrogen, or moisture, the current collector is transferred in an argon atmosphere after formation of the lithium metal film, layered with the separator and the positive electrode, bonded to the lead electrode, and then sealed with the exterior body. The positive electrode includes a positive electrode current collector and a positive electrode active material layer, and the positive electrode active material will be described later.

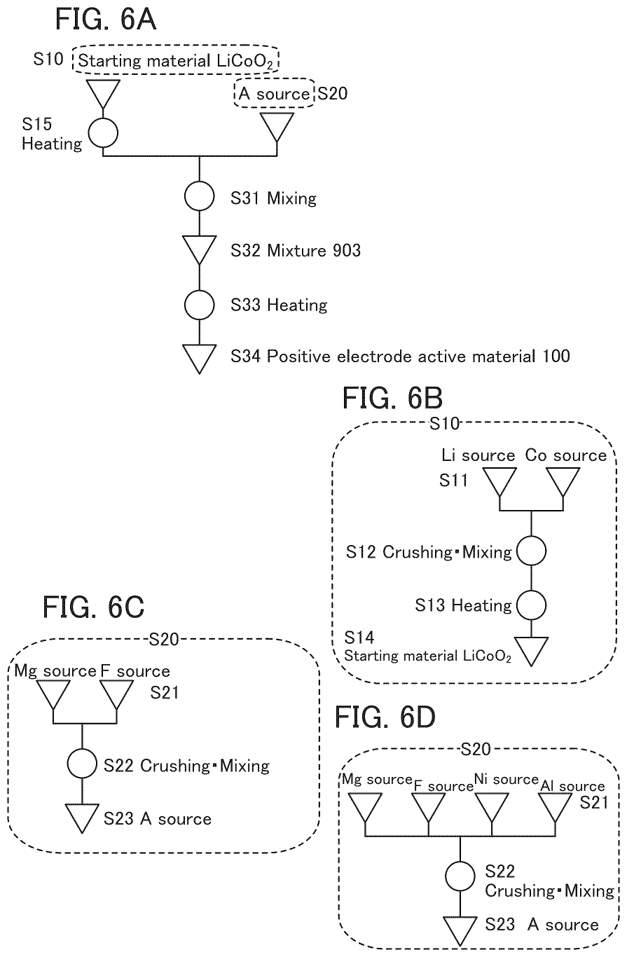

Next, a method for forming a positive electrode active material that can be applied to a positive electrode of the secondary battery 10 will be described with reference to FIG. 6A to FIG. 6D.

### <Formation Method Example 1 of Positive Electrode Active Material>

First, lithium cobalt oxide is prepared as a starting material in Step S10. The particle diameter (strictly, median diameter) of the lithium cobalt oxide that is a starting material can be less than or equal to 10 μm (preferably less than or equal to 8 μm). Note that in this specification and the like, unless otherwise specified, a median diameter refers to D50 on the assumption that particle size distribution is bilaterally symmetrical. Note that D50 refers to a 50% cumulative secondary particle diameter calculated using a particle size distribution analyzer (SALD-2200 manufactured by Shimadzu Corporation) using a laser diffraction and scattering method. The particle size may be measured by measuring the major diameter of the cross section of the particle obtained by analysis with a SEM, a transmission electron microscope (TEM), or the like, instead of using laser diffraction particle size distribution measurement. Note that an example of a method for measuring D50 with a SEM, TEM, or the like includes a method for measuring 20 or more particles to make a particle size distribution curve, and setting a particle diameter when the accumulation of particles accounts for 50% as D50. Lithium cobalt oxide with a median diameter of less than or equal to 10 μm may be known or official (in short, commercially available) lithium cobalt oxide or lithium cobalt oxide formed through Step S11 to Step S14 shown FIG. 6B. As a typical example of the commercially available lithium cobalt oxide with a median diameter of less than or equal to 10 μm, lithium cobalt oxide produced by NIPPON CHEMICAL INDUSTRIAL CO., LTD. (product name: C-5H) can be given. The lithium cobalt oxide produced by NIPPON CHEMICAL INDUSTRIAL CO., LTD. (product name: C-5H) has a median diameter of approximately 7 μm. A method for forming lithium cobalt oxide with a median diameter of less than or equal to 10 μm through Step S11 to Step S14 is described below.

### <Step S11>

In Step S11 shown in FIG. 6B, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide or cobalt hydroxide can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and increased reliability can be obtained.

Furthermore, the cobalt source preferably has high crystallinity, and preferably includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, or an ABF-STEM (annular bright-field scanning transmission electron microscope) image, or can be judged by X-ray diffraction (XRD), electron diffraction, neutron diffraction, or the like. Note that the above methods for evaluating crystallinity can also be employed to evaluate the crystallinity of other materials in addition to the transition metal source.

### <Step S12>

Next, in Step S12 shown in FIG. 6B, the lithium source and the cobalt source are ground and mixed to form a mixed material. The grinding and mixing can be performed by a dry method or a wet method. To obtain lithium cobalt oxide with a median diameter of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used as a means for the grinding and mixing, for example. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, the materials mixed in the above manner are heated in Step S13 shown in FIG. 6B. The heating temperature is preferably higher than or equal to 800° C. and lower than or equal to 1100° C., further preferably higher than or equal to 900° C. and lower than or equal to 1000° C., still further preferably approximately 950° C. and lower than or equal to 1000° C. An excessively low temperature might lead to insufficient decomposition and melting of the lithium source and the transition metal source. An excessively high temperature might lead to a defect due to evaporation of lithium from the lithium source and/or excessive reduction of cobalt. For example, an oxygen defect which could be induced by a change of trivalent cobalt into divalent cobalt.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours, still further preferably longer than or equal to 2 hours and shorter than or equal to 10 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and the dew point of the atmosphere is preferably lower than or equal to −50° C., further preferably lower than or equal to −80° C., for example. In this embodiment, the heating is performed in an atmosphere with a dew point of −93° C. To reduce impurities that might enter the material, the concentrations of impurities such as CH₄, CO, CO₂, or H₂ in the heating atmosphere are each preferably lower than or equal to 5 ppb (parts per billion).

The heating atmosphere is preferably an oxygen-containing atmosphere. For example, one method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container used at the time of the heating is preferably a crucible or a sagger made of aluminum oxide. The crucible made of aluminum oxide has a material property that hardly allows the entry of impurities. In this embodiment, a sagger made of aluminum oxide with a purity of 99.9% is used. Note that the heating is preferably performed with the crucible or the sagger covered with a lid, in which case volatilization of a material can be prevented.

After the heating, the heated material is ground as needed and may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 6B. The lithium cobalt oxide (LiCoO₂) shown in Step S14 is an oxide containing a plurality of metal atoms in its structure and thus can be referred to as a composite oxide. A “composite oxide” in this specification and the like refers to an oxide containing a plurality of metal atoms in its structure. Note that the lithium cobalt oxide (LiCoO₂) shown in Step S14 may be obtained after adjusting particle size distribution by performing a grinding step and a classification step after Step S13.

Although the example is described in which the composite oxide is formed by a solid phase method as in Step S11 to Step S14, the composite oxide may be formed by a coprecipitation method. Alternatively, the composite oxide may be formed by a hydrothermal method.

Through Step S11 to Step S14, lithium cobalt oxide that is a starting material for a positive electrode active material applicable to a lithium ion battery having excellent discharge characteristics even in a low-temperature environment can be obtained. Specifically, as the lithium cobalt oxide that is a starting material, lithium cobalt oxide with a median diameter of less than or equal to 10 μm can be obtained.

### <Step S15>

Next, as Step S15 shown in FIG. 6A, the lithium cobalt oxide that is a starting material is heated. The heating in Step S15 is the first heating performed on the lithium cobalt oxide and thus is sometimes referred to as the initial heating in this specification and the like. The heating is performed before Step S31 described below, and thus is sometimes referred to as preheating or pretreatment.

By the initial heating, lithium is extracted from part of the surface portion of the lithium cobalt oxide. In addition, an effect of increasing the crystallinity of the inner portion can be expected. Although the lithium source and/or the cobalt source prepared in Step S11 might contain impurities, impurities in the lithium cobalt oxide that is a starting material can be reduced by the initial heating. Note that the effect of increasing the crystallinity of the inner portion is, for example, an effect of reducing distortion and a shift derived from differential shrinkage of the lithium cobalt oxide formed in Step S14.

Through the initial heating, an effect of smoothing the surface of the lithium cobalt oxide is obtained. In this specification and the like, a smooth surface refers to a state of having little unevenness and being rounded as a whole, and its corner portion is rounded. A smooth surface also refers to a surface to which few foreign matters are attached. Foreign matters are deemed to cause unevenness and are preferably not attached to a surface.

For the initial heating, a lithium compound source, an additive element A source, or a material functioning as a fusing agent is not necessarily separately prepared.

When the heating time in this step is too short, a sufficient effect is not obtained, but when the heating time in this step is too long, the productivity is lowered. For example, as an appropriate range of the heating time, any of the heating conditions described for Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, Step S15 can reduce the differential shrinkage caused in the lithium cobalt oxide and make the surface of the composite oxide smooth.

Such differential shrinkage might cause a micro shift in the lithium cobalt oxide such as a shift in a crystal. To reduce this shift, Step S15 is preferably performed. Performing Step S15 can distribute a shift uniformly in the composite oxide (reduce the shift in a crystal which is caused in the composite oxide or align crystal grains). As a result, the surface of the composite oxide becomes smooth.

In a secondary battery including lithium cobalt oxide with a smooth surface as a positive electrode active material, deterioration by charge and discharge is suppressed and a crack in the positive electrode active material can be prevented.

Note that pre-synthesized lithium cobalt oxide with a median diameter of less than or equal to 10 μm may be used in Step S10 as described above. In that case, Step S11 to Step S13 can be omitted. When Step S15 is performed on the pre-synthesized lithium cobalt oxide, lithium cobalt oxide with a smooth surface can be obtained.

Note that Step S15 is not essential in one embodiment of the present invention; thus, an embodiment in which Step S15 is skipped is also included in one embodiment of the present invention.

### <Step S20>

Next, details of Step S20 of preparing the additive element A as the A source are described with reference to FIG. 6C and FIG. 6D.

### <Step S21>

Step S20 shown in FIG. 6C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. Alternatively, one or more selected from bromine and beryllium can be used. FIG. 6C shows an example of the case where a magnesium source (Mg source) and a fluorine source (F source) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), or magnesium carbonate (MgCO₃) can be used. Two or more of these magnesium sources may be used.

When fluorine is selected as the additive element A, the additive element A source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), or sodium aluminum hexafluoride (Na₃AlF₆) can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, or oxygen fluoride (OF₂, O₂F₂, O₃F₂, O₄F₂, O₅F₂, O₆F₂, and O₂F) may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x is an approximate value of 0.33). Note that in this specification, the expression “an approximate value of a given value” means greater than 0.9 times and less than 1.1 times the given value, unless otherwise specified.

### <Step S22>

Next, in Step S22 shown in FIG. 6C, the magnesium source and the fluorine source are ground and mixed. Any of the conditions for grinding and mixing that are described for Step S12 can be selected to perform this step.

### <Step S23>

Next, in Step S23 shown in FIG. 6C, the materials ground and mixed in the above step are collected to give the additive element A source (A source). Note that the additive element A source in Step S23 contains a plurality of starting materials and can be referred to as a mixture.

As for the particle diameter of the mixture, the median diameter is preferably greater than or equal to 100 nm and less than or equal to 10 μm, further preferably greater than or equal to 300 nm and less than or equal to 5 μm. When one kind of material is used as the additive element A source, the median diameter is also preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion of the composite oxide after heating.

### <Step S21>

A process different from that in FIG. 6C is described with reference to FIG. 6D. Step S20 shown in FIG. 6D includes Step S21 to Step S23.

In Step S21 shown in FIG. 6D, four kinds of additive element A sources to be added to the lithium cobalt oxide are prepared. In other words, FIG. 6D is different from FIG. 6C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (Al source) are prepared. The magnesium source and the fluorine source can be selected from the compounds described with reference to FIG. 6C. As a nickel source, nickel oxide or nickel hydroxide can be used. As an aluminum source, aluminum oxide or aluminum hydroxide can be used.

### <Step S22 and Step S23>

Next, Step S22 and Step S23 shown in FIG. 6D are similar to Step S22 and Step S23 shown in FIG. 6C.

### <Step S31>

Next, in Step S31 shown in FIG. 6A, the lithium cobalt oxide that has been subjected to Step S15 (initial heating) and the additive element A source (Mg source) are mixed. Here, the atomic ratio of cobalt Co in the lithium cobalt oxide that has been subjected to Step S15 to magnesium Mg contained in the additive element A is preferably Co:Mg=100:y (0.1≤y≤6), further preferably Co:Mg=100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S51 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A, the mixing in Step S51 is preferably performed such that the number of aluminum atoms in the aluminum source is greater than or equal to 0.05% and less than or equal to 4% of the number of cobalt atoms in the lithium cobalt oxide that has been subjected to Step S15.

The condition of the mixing in Step S31 is preferably milder than that of the grinding and mixing in Step S12 not to damage the lithium cobalt oxide shape. For example, a condition with a smaller number of rotations or a shorter time than that of the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 6A, the materials mixed in the above manner are collected, whereby a mixture 903 is obtained. At the time of the collection, the materials may be crushed as needed and made to pass through a sieve.

### <Step S33>

Then, in Step S33 shown in FIG. 6A, the mixture 903 is heated. The heating in Step S33 is preferably performed at higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in lithium cobalt oxide and the additive element A source occurs, and may be lower than the melting temperatures of these materials. In the case where an oxide is described as an example, solid phase diffusion occurs at the temperature of 0.757 times the melting temperature Tₘ(Tammann temperature Td); thus, the heating temperature in Step S33 is higher than or equal to 500° C.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source is preferably controlled to be within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

Since LiF in a gas phase has a specific gravity less than that of oxygen, heating might volatilize LiF and in that case, LiF in the mixture 903 decreases. In this case, the function of a fusing agent deteriorates. Therefore, heating is preferably performed while volatilization of LiF is inhibited. Note that even when LiF is not used as the fluorine source, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the mixtures 903 are not adhered to each other. Adhesion of the mixtures 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

Uniform distribution of the additive element (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

### <Step S34>

Next, the heated material is collected in Step S34 shown in FIG. 6A, in which crushing is performed as needed; thus, a positive electrode active material 100 is obtained. Here, the collected positive electrode active material 100 is preferably made to pass through a sieve. Through the above process, the positive electrode active material 100 (composite oxide) with a median diameter of less than or equal to 12 μm (preferably less than or equal to 10.5 μm, further preferably less than or equal to 8 μm) can be formed. Note that the positive electrode active material 100 contains the additive element A.

### <Example 2 of Method for Forming Positive Electrode Active Material>

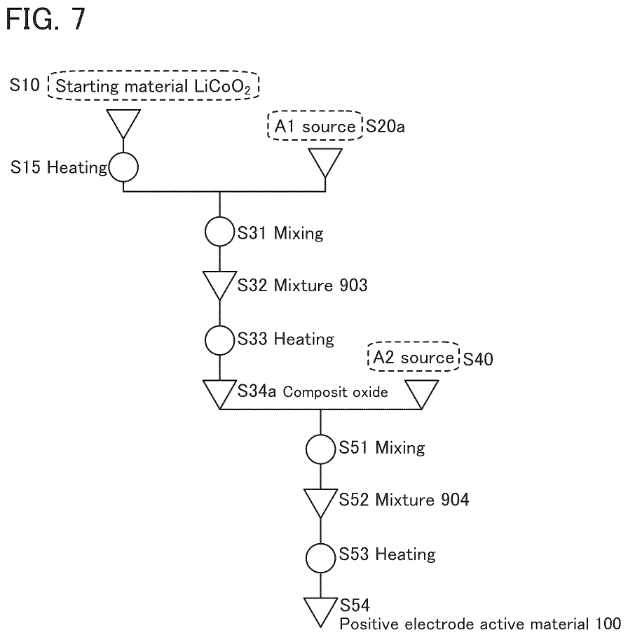

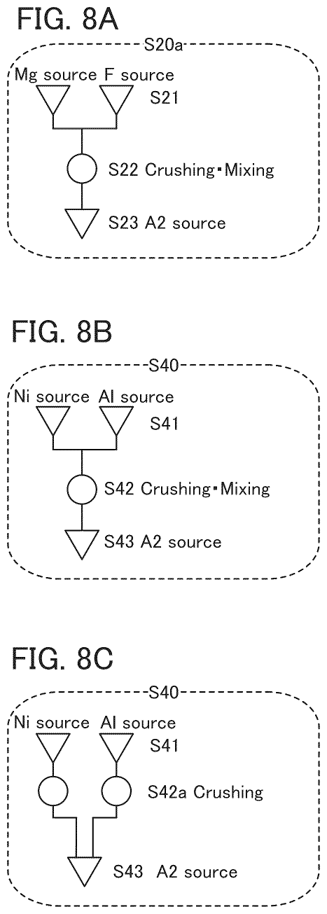

Another example of a method for forming the positive electrode active material that can be used as one embodiment of the present invention (Example 2 of method for forming positive electrode active material) is described with reference to FIG. 7 and FIG. 8. Although Example 2 of method for forming positive electrode active material is different from Example 1 of method for forming positive electrode active material described above in the number of times of adding the additive element and a mixing method, for the description except for the above, the description of Example 1 of method for forming positive electrode active material can be referred to.

Step S10 to Step S15 in FIG. 7 are performed as in FIG. 6A to prepare lithium cobalt oxide that has been subjected to the initial heating. Note that Step S15 is not essential in one embodiment of the present invention; thus, an embodiment in which Step S15 is skipped is also included in one embodiment of the present invention.

### <Step S20a>

Next, as shown in Step S20a, a first additive element A1 source (A1 source) is prepared. Step S20a is described in detail with reference to FIG. 8A.

### <Step S21>

In Step S21 shown in FIG. 8A, the first additive element A1 source (A1 source) is prepared. The A1 source can be selected from the additive elements A described for Step S21 shown in FIG. 6C to be used. For example, one or more selected from magnesium, fluorine, and calcium can be used as the additive element A1. FIG. 8A shows an example of the case where a magnesium source (Mg source) and a fluorine source (F source) are used as the additive element A1.

Step S21 to Step S23 shown in FIG. 8A can be performed under the same conditions as those in Step S21 to Step S23 shown in FIG. 6C. As a result, the additive element A1 source (A1 source) can be obtained in Step S23.

Steps S31 to Step S33 shown in FIG. 7 can be performed under the same conditions as those in Steps S31 to Step S33 shown in FIG. 6A.

### <Step S34a>

Next, the material heated in Step S33 is collected to obtain lithium cobalt oxide containing the additive element A1. Here, the composite oxide is called a second composite oxide to be distinguished from the lithium cobalt oxide that has been subjected to Step S15 (first composite oxide).

### <Step S40>

In Step S40 shown in FIG. 7, a second additive element A2 source (A2 source) is prepared. Step S40 is described with reference to FIG. 8B and FIG. 8C.

### <Step S41>

In Step S40 shown in FIG. 8B, the second additive element A2 source (A2 source) is prepared. The A2 source can be selected from the additive elements A described for Step S20 shown in FIG. 6C. For example, one or more selected from nickel, titanium, boron, zirconium, and aluminum can be suitably used as the additive element A2. FIG. 8B shows an example of the case where nickel and aluminum are used as the additive element A2.

Step S41 to Step S43 shown in FIG. 8B can be performed under the same conditions as those in Step S21 to Step S23 shown in FIG. 6C. As a result, the additive element A2 source (A2 source) can be obtained in Step S43.

FIG. 8C showing Step S41 to Step S43 is a modification example of FIG. 8B. A nickel source (Ni source) and an aluminum source (Al source) are prepared in Step S41 shown in FIG. 8C and are separately ground in Step S42a. Accordingly, a plurality of the second additive element A2 sources (A2 sources) are prepared in Step S43. As described above, Step S40 in FIG. 8C is different from Step S40 in FIG. 8B in that the additive elements are separately ground in Step S42a.

### <Step S51 to Step S53>

Next, Step S51 to Step S53 shown in FIG. 7 can be performed under the same conditions as those in Step S31 to Step S34 shown in FIG. 6A. The heating in Step S53 is preferably performed at a lower temperature and/or in a shorter time than the heating in Step S33 shown in FIG. 7. Specifically, the heating temperature is preferably higher than or equal to 800° C. and lower than or equal to 950° C., further preferably at higher than or equal to 820° C. and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide that has been subjected to Step S15.

### <Step S54>

Next, the heated material is collected and crushing is performed as needed to obtain the positive electrode active material 100 in Step S54 shown in FIG. 7. Through the above process, the positive electrode active material 100 (composite oxide) with a median diameter of less than or equal to 12 μm (preferably less than or equal to 10.5 μm, further preferably less than or equal to 8 μm) can be formed. Alternatively, the positive electrode active material 100 applicable to a lithium ion battery having excellent discharge characteristics even in a low-temperature environment can be formed. Note that the positive electrode active material 100 contains the additive element A1 and the additive element A2.

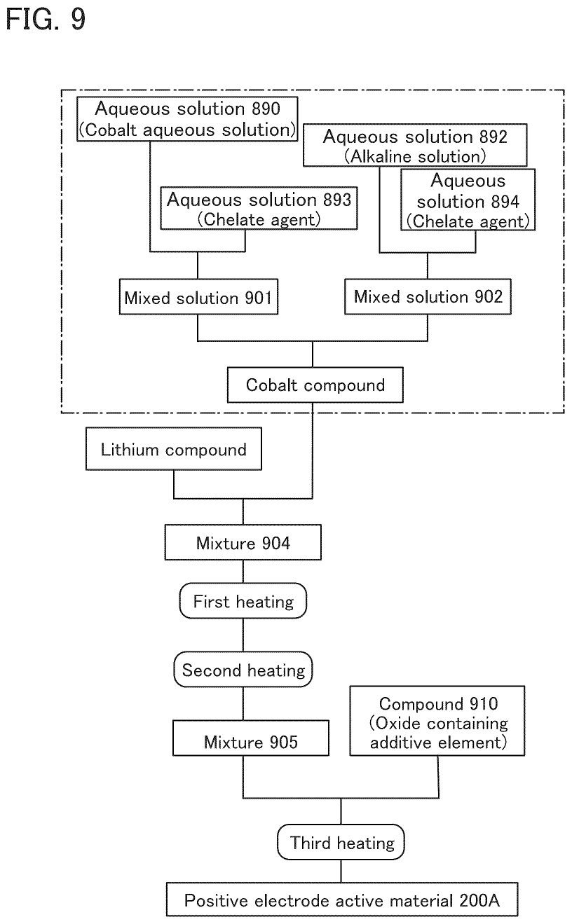

In the example 2 of a formation method described above, as shown in FIG. 7 and FIG. 9, introduction of the additive element to the lithium cobalt oxide is divided into introduction of the first additive element A1 and that of the second additive element A2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion. The positive electrode active material 100 formed through the steps in FIG. 6A and FIG. 6D has an advantage of being formed at low cost since a plurality of kinds of additive elements A are added at the same time. Meanwhile, although the formation cost of the positive electrode active material 100 formed through FIG. 7 and FIG. 8 is relatively high since a plurality of kinds of additive elements A are added in a plurality of steps, a profile of each of the additive elements A in the depth direction can be more accurately controlled, which is preferable.

### Embodiment 2

Although examples of a positive electrode active material formed using a solid phase method are described in Embodiment 1, an example of a method for forming a positive electrode active material 200A in which an additive element is added to a cobalt compound obtained by a coprecipitation method will be described in this embodiment with reference to FIG. 9. Note that the flow chart in FIG. 9 shows the order of components connected with lines. The flow chart does not show timing for the components not directly connected with lines. For example, although formation of a mixed solution 901 and formation of a mixed solution 902 are shown at the same level in FIG. 9, they are not necessarily performed at the same time.

Employed in this embodiment is a process in which a coprecipitation precursor where Co, Ni, and Mn exists in one particle is formed by a coprecipitation method, a Li salt is mixed to the coprecipitation precursor, heating is performed twice, and then aluminum is added. Note that in the case where NCM is used as a positive electrode active material without aluminum addition, a positive electrode active material can be formed by mixing Li salts to the coprecipitation precursor and then performing heating twice.

As illustrated in FIG. 9, a cobalt aqueous solution is prepared as an aqueous solution 890, and an alkaline solution is prepared as an aqueous solution 892. The aqueous solution 890 and an aqueous solution 893 are mixed to form the mixed solution 901. The aqueous solution 892 and an aqueous solution 894 are mixed to form the mixed solution 902. These mixed solutions 901 and 902 are made to react to form a cobalt compound. This reaction is referred to as a neutralization reaction, an acid-base reaction, or a coprecipitation reaction, and this cobalt compound is referred to as a precursor of lithium cobalt oxide in some cases. Note that a reaction caused by performing steps surrounded by the chain line in FIG. 9 can be referred to as a coprecipitation reaction.

### <Cobalt Aqueous Solution>

As the cobalt aqueous solution, an aqueous solution containing cobalt sulfate (e.g., CoSO₄), cobalt chloride (e.g., CoCl₂), cobalt nitrate (e.g., Co(NO₃)₂), cobalt acetate (e.g., C₄H₆COO₄), cobalt alkoxide, an organocobalt complex, or hydrate of any of these is given. Alternatively, an organic acid of cobalt, such as cobalt acetate, or hydrate of the organic acid of cobalt may be used. Note that in this specification, the organic acid includes citric acid, oxalic acid, formic acid, and butyric acid, in addition to acetic acid.

For example, an aqueous solution obtained by dissolving these in pure water can be used. The cobalt aqueous solution shows acidity, and thus can be referred to as an acid aqueous solution. The cobalt aqueous solution can be referred to as a cobalt source in a formation process of a positive electrode active material.

### <Alkaline Solution>

As the alkaline solution, an aqueous solution containing sodium hydroxide, potassium hydroxide, lithium hydroxide, or ammonia is given. For example, an aqueous solution obtained by dissolving these in pure water can be used. An aqueous solution in which two or more kinds selected from sodium hydroxide, potassium hydroxide, and lithium hydroxide are dissolved in pure water may be used.

### <Reaction Conditions>

In the case where the aqueous solution 890 and the aqueous solution 892 are made to react by the coprecipitation method, the pH of the reaction system is set to greater than or equal to 9.0 and less than or equal to 11.0, preferably greater than or equal to 9.8 and less than or equal to 10.3. For example, in the case where the aqueous solution 892 is put into a reaction vessel and the aqueous solution 890 is dripped into the reaction vessel, the pH of the aqueous solution in the reaction vessel is preferably kept in the above range. The same applies to the case where the aqueous solution 890 is put into the reaction vessel and the aqueous solution 892 is dripped. The dripping rate of the aqueous solution 890 or the aqueous solution 892 is preferably greater than or equal to 0.1 mL/min. and less than or equal to 0.8 mL/min., in which case the pH condition can be controlled easily. The reaction vessel contains at least a reaction container.

An aqueous solution in the reaction vessel is preferably stirred with a stirring means. The stirring means includes a stirrer, an agitator blade, or the like. Two to six agitator blades can be provided; for example, in the case where four agitator blades are provided, they may be placed in a cross shape seen from above. The number of rotations of the stirring means is preferably greater than or equal to 800 rpm and less than or equal to 1200 rpm.

The temperature in the reaction vessel is adjusted to be higher than or equal to 50° C. and lower than or equal to 90° C. The dripping of the aqueous solution 892 or the aqueous solution 890 is preferably started after the temperature becomes the above temperature.

The reaction vessel preferably has an inert atmosphere. For example, in the case of a nitrogen atmosphere, a nitrogen gas is preferably introduced at a flow rate of 0.5 L/min. or more and 2 L/min. or less.

In the reaction vessel, a reflux condenser is preferably placed. The nitrogen gas can be released from the reaction vessel and water can be returned to the reaction vessel with use of the reflux condenser.

Through the above reaction, a cobalt compound is precipitated in the reaction vessel. Filtration is performed to collect the cobalt compound. After a reaction product precipitated in the reaction vessel is washed with pure water, an organic solvent (e.g., acetone) having a low boiling point is preferably added before the filtration is performed.

The cobalt compound after the filtration is preferably dried. For example, drying is performed under vacuum at higher than or equal to 60° C. and lower than or equal to 90° C. for longer than or equal to 0.5 hours and shorter than or equal to 3 hours. In this manner, the cobalt compound can be obtained.

The cobalt compound obtained through the above reaction includes cobalt hydroxide (e.g., Co(OH)₂). The cobalt hydroxide after the filtration is obtained in the state of secondary particles which are aggregations of primary particles. Note that in this specification, a primary particle refers to a particle (lump) of the smallest unit having no grain boundary when being observed, for example, at a magnification of 5000 times with a SEM (scanning electron microscope) or the like. In other words, the primary particle means a particle of the smallest unit surrounded by a grain boundary. A secondary particle refers to a particle in which the primary particles are aggregated, partially sharing the grain boundary (the circumference and the like of the primary particle), and are not easily separated from each other (a particle independent of the other particles). That is, the secondary particle has a grain boundary in some cases.

Next, a lithium compound is prepared.

### <Lithium Compound>

As the lithium compound, lithium hydroxide (e.g., LiOH), lithium carbonate (e.g., Li₂CO₃), or lithium nitrate (e.g., LiNO₃) can be given. In particular, a material having a low melting point among lithium compounds, such as lithium hydroxide (melting point: 462° C.), is preferably used. Since a positive electrode active material having a high nickel proportion is likely to cause cation mixing as compared to lithium cobalt oxide and the like, first heating needs to be performed at a low temperature. Therefore, it is preferable to use a material having a low melting point.

In this embodiment, the cobalt compound and the lithium compound are weighed out to have desired amounts and mixed to form a mixture 904. For the mixing, a mortar or a stirring mixer is used.

Next, first heating is performed. An electric furnace or a rotary kiln furnace can be used as a firing device for the first heating.

Then, grinding or crushing is performed with a mortar to loosen the secondary particles fixed one another, and the ground or crushed mixture is collected. Furthermore, classification may be performed using a sieve. In this embodiment, a crucible made of aluminum oxide (also referred to as alumina) with a purity of 99.9% is used. It is suitable to collect the heated materials after the materials are transferred from the crucible to a mortar in order to prevent impurities from entering the materials. The mortar is suitably made of a material which is difficult to release impurities. Specifically, it is suitable to use a mortar made of alumina with a purity of 90% or higher, preferably 99% or higher.

Next, second heating is performed. An electric furnace or a rotary kiln furnace can be used as a firing device for the second heating.

The temperature of the second heating is at least higher than the temperature of the first heating and is preferably higher than 700° C. and lower than or equal to 1050° C. The time of the second heating is preferably longer than or equal to 1 hour and shorter than or equal to 20 hours. The second heating is preferably performed in an oxygen atmosphere, and in particular, preferably performed while oxygen is supplied. For example, the oxygen supply is performed at 10 L/min. per liter of inner capacity of the furnace. Specifically, the heating is preferably performed in a state where a container containing the mixture 904 is covered with a lid.

Then, grinding or crushing is performed with a mortar to loosen the secondary particles fixed one another, and the ground or crushed mixture is collected. Furthermore, classification may be performed using a sieve.

Then, an obtained mixture 905 and a compound 910 are mixed.

### <Compound 910>

As the additive element source, one or more selected from an aluminum salt, a magnesium salt, and a calcium salt are used. As the compound 910, one or more selected from aluminum oxide, aluminum hydroxide, magnesium oxide, magnesium hydroxide, basic magnesium carbonate ((MgCO₃)₃Mg(OH)₂ₓ3H₂O), calcium oxide, calcium carbonate, and calcium hydroxide are used. In this embodiment, aluminum is used as the additive element source and aluminum hydroxide (Al(OH)₃) is used as the compound 910. The compound 910 used as the additive element source is preferably weighed in a range of 0.5 atm % to 3 atm % and added by a practitioner as appropriate so that a desired amount of the compound 910 is contained in consideration of the compositions of the lithium compound and the cobalt compound.

Then, third heating is performed. The third heating temperature is at least higher than the first heating temperature and is preferably higher than 700° C. and lower than or equal to 1050° C. The time of the third heating is preferably shorter than that of the second heating and longer than or equal to 1 hour and shorter than or equal to 20 hours. The third heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 905 is covered with a lid.

Then, grinding or crushing is performed with a mortar to loosen the secondary particles fixed one another, and the ground or crushed mixture is collected. Furthermore, classification may be performed using a sieve. With the crushing step, the grain size and/or the shape of the positive electrode active material 200A can be uniformized

Through the above steps, the positive electrode active material 200A can be formed. The positive electrode active material 200A obtained through the above steps is Al-added NCM and thus referred to as NCMA in some cases.

Although FIG. 9 illustrates an example of flow in which aluminum as an additive is added after mixing with the lithium compound, one embodiment of the present invention is not limited thereto, and aluminum as an additive can be added by a coprecipitation method. When aluminum as an additive is added by a coprecipitation method, an aqueous solution of aluminum sulfate, aluminum chloride, aluminum nitrate, or a hydrate thereof can be used. When magnesium as an additive is added by a coprecipitation method, an aqueous solution of magnesium sulfate, magnesium chloride, magnesium nitrate, or a hydrate thereof can be used.

A coprecipitation apparatus for performing the coprecipitation method is described below.

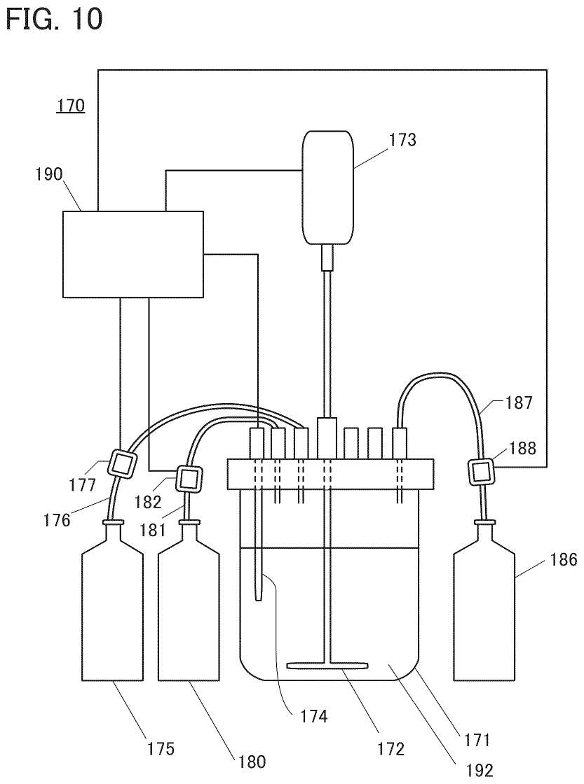

A coprecipitation synthesis apparatus 170 illustrated in FIG. 10 includes a reaction vessel 171, and the reaction vessel 171 contains a reaction container. A separable flask is preferably used in the lower part of the coprecipitation synthesis apparatus 170 and a separable cover is preferably used in the upper part of the coprecipitation synthesis apparatus 170. The separable flask may be cylindrical or round type. A cylindrical separable flask has a flat bottom. The atmosphere of the reaction vessel 171 can be controlled with at least one inlet of the separable cover. For example, the atmosphere preferably contains nitrogen. In that case, it is preferable to make nitrogen flow in the reaction vessel 171. Nitrogen is preferably subjected to bubbling in an aqueous solution 192 in the reaction vessel 171. The coprecipitation synthesis apparatus 170 may be equipped with a reflux condenser connected to at least one inlet of the separable cover. This reflux condenser allows an atmosphere gas in the reaction vessel 171, e.g., nitrogen, to be ejected and water to return to the reaction vessel 171. In the atmosphere of the reaction vessel 171, it is acceptable that the amount of streaming air necessary for ejecting a gas generated by a pyrolytic reaction due to heat treatment is maintained.

The procedure of a coprecipitation method surrounded by the chain line in FIG. 9 is described with reference to FIG. 9 and FIG. 10.

First, the aqueous solution 894 (chelating agent) is put in the reaction vessel 171, and then the mixed solution 901 and the aqueous solution 892 (alkaline solution) are dripped into the reaction vessel 171. The aqueous solution 192 in FIG. 3 is in the state where dripping has started. Note that the aqueous solution 894 is sometimes referred to as a filling liquid. In some cases, the filling liquid is described as an adjustment liquid, and denotes an aqueous solution before a reaction, that is, an initial aqueous solution.

The other components of the coprecipitation synthesis apparatus 170 illustrated in FIG. 10 are described. The coprecipitation synthesis apparatus 170 is equipped with a stirrer 172, a stirring motor 173, a thermometer 174, a tank 175, a tube 176, a pump 177, a tank 180, a tube 181, a pump 182, a tank 186, a tube 187, a pump 188, a control device 190, and the like.

The stirrer 172 can stir the aqueous solution 192 in the reaction vessel 171, and the stirrer motor 173 is included as a power source that makes the stirrer 172 rotate. The stirrer 172 includes a paddle-type agitator blade (denoted as a paddle blade), and the paddle blade includes two to six blades. The blade may have an inclination of greater than or equal to 40 degrees and less than or equal to 70 degrees.

The thermometer 174 can measure the temperature of the aqueous solution 192. The temperature of the reaction vessel 171 can be controlled using a thermoelectric element such that the temperature of the aqueous solution 192 is constant. An example of the thermoelectric element is a Peltier element. Although not shown, a pH meter is also provided in the reaction vessel 171, and the pH of the aqueous solution 192 can be measured.

Different aqueous solutions of source materials can be pooled in the tanks. For example, the tanks can be filled with the mixed solution 901 and the aqueous solution 892. A tank filled with the aqueous solution 894 serving as a filling liquid may be prepared. Each tank is equipped with a pump and an aqueous solution of a source material can be dripped into the reaction vessel 171 through a tube with use of the pump. The dripping amount of the aqueous solution of a source material, that is the amount of the delivered liquid, can be controlled with the pump. In addition to the pump, a valve may be provided for the tube 176, and the dripping amount of the aqueous solution of the source material, i.e., the amount of the delivered liquid may be controlled with the valve.

The control device 190 is electrically connected to the stirrer motor 173, the thermometer 174, the pump 177, the pump 182, and the pump 188, and can control the number of rotations of the stirrer 172, the temperature of the aqueous solution 192, the dripping amounts of the aqueous solutions of source materials, and the like.

The number of rotations of the stirrer 172, specifically, the number of rotations of the paddle blade is preferably, for example, greater than or equal to 800 rpm and less than or equal to 1200 rpm. The stirring is preferably performed while the aqueous solution 192 is heated at a temperature higher than or equal to 50° C. and lower than or equal to 90° C. In the stirring, the mixed solution 901 is preferably dripped into the reaction vessel 171 at a constant rate. Needless to say, the rotation number of the paddle blade is not limited to a constant number, and can be appropriately controlled. For example, the rotation number can be changed depending on the liquid amount of the reaction vessel 171. Moreover, the dripping rate of the mixed solution 901 or the like can be adjusted. The dripping rate can be controlled to keep the pH of the reaction vessel 171 constant. The dripping rates may be controlled so that the aqueous solution 892 is dripped when the pH varies from a desired pH value during the dripping of the mixed solution 901. The pH value is greater than or equal to 9.0 and less than or equal to 11.0, preferably greater than or equal to 9.8 and less than or equal to 10.3.

Through the above process, a reaction product is precipitated in the reaction vessel 171. The reaction product includes a cobalt compound. This reaction can be referred to as coprecipitation or coprecipitation, and this step is referred to as a coprecipitation step in some cases.

This embodiment can be freely combined with the other embodiments.

### Embodiment 3

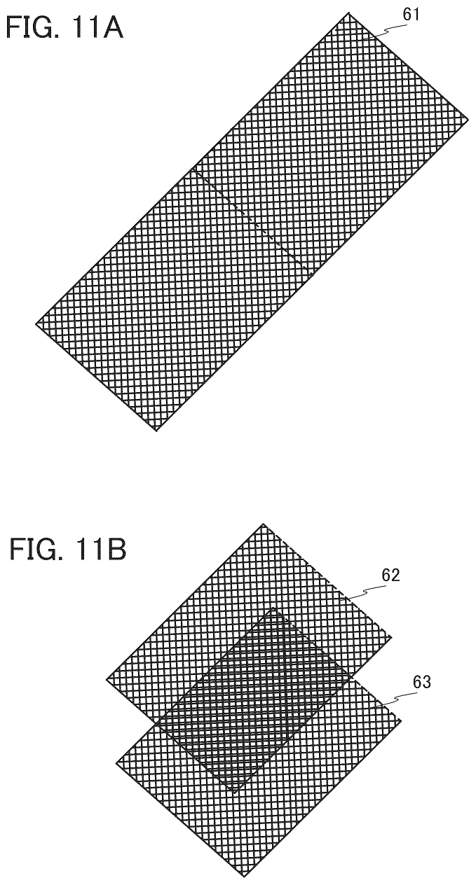

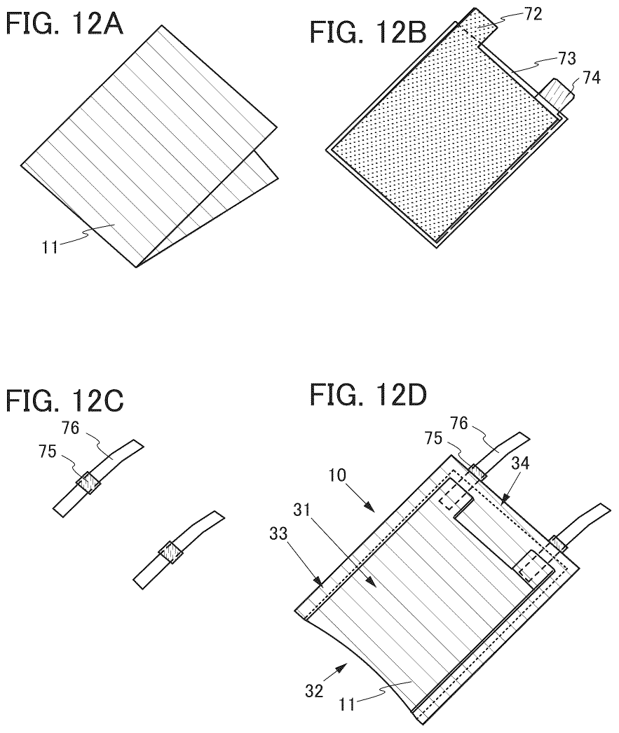

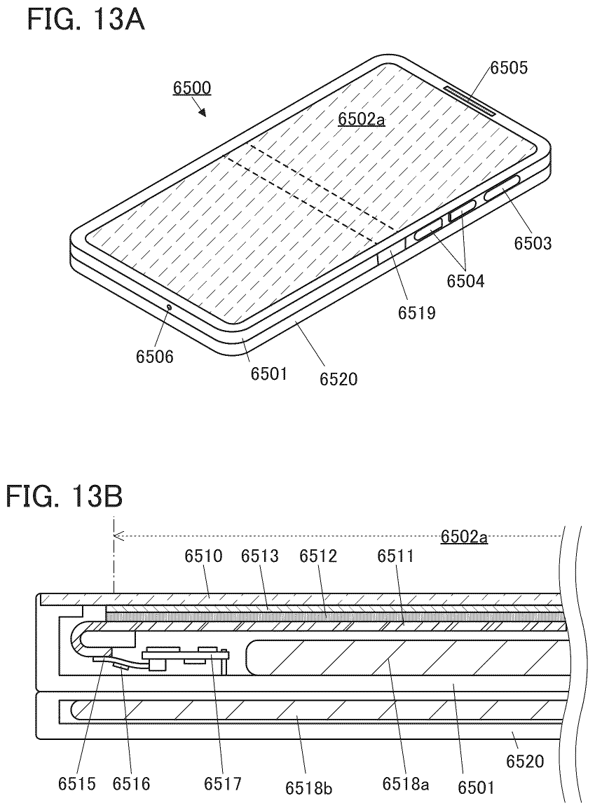

A fabricating example of a bendable secondary battery is described with reference to FIG. 11, FIG. 12, and FIG. 13.

FIG. 11A and FIG. 11B are bird's-eye views illustrating examples of an intersecting corrugated shape obtained by two embossing processes on the exterior body that is a film while changing the direction of the exterior body.

Specifically, corrugated embossing is performed on an exterior body made of a film in the first direction, and then corrugated embossing is performed on the exterior body in the second direction that is rotated 90° with respect to the first direction, whereby a film 61 having an embossed shape (that can be referred to as an intersecting corrugated shape) illustrated in FIG. 11A and FIG. 11B can be obtained. Note that when a secondary battery is fabricated using one film 61, the film 61 having an intersecting corrugated shape has an external shape illustrated in FIG. 11A and can be used in a state of being bent in two along a dashed line portion. When a secondary battery is fabricated using two films (a film 62 and a film 63), the plurality of films (the film 62 and the film 63) each having an intersecting corrugated shape have an external shape illustrated in FIG. 11B, and the film 62 and the film 63 can overlap with each other to be used.

The exterior body in FIG. 1C is obtained by performing corrugated embossing on the exterior body in the first direction for only once.

Since processing is performed using the embossing rolls, an apparatus can be small. Furthermore, a film before being cut can be processed, achieving excellent productivity. Note that a film processing method is not limited to processing using embossing rolls; a film may be processed by pressing a pair of embossing plates having a surface with unevenness against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

### [Example of Method for Fabricating Secondary Battery]

An example of a fabrication method particularly when a secondary battery is used as a secondary battery 10 will be described below. Note that points similar to those described above are not described in some cases.

Here, a method in which an exterior body 11 having a corrugated shaped film cross section, is bent in half so that two end portions overlap with each other and three sides are sealed with an adhesive layer is employed.

The exterior body 11 processed to have a corrugated shape is bent to be in the state illustrated in FIG. 12A.

As illustrated in FIG. 12B, a laminate including a positive electrode current collector 72, a separator 73, and a negative electrode current collector 74 included in a secondary battery is prepared. Although not illustrated, a positive electrode active material layer is formed on part of the surface of the positive electrode current collector 72. In addition, a lithium metal film as a negative electrode active material layer is formed over part of the surface of the negative electrode current collector 74. Here, for simple description, an example is described in which one laminate including the positive electrode current collector 72 provided with the positive electrode active material layer, the separator 73, and the negative electrode current collector 74 provided with the negative electrode active material layer is held in a space formed of an exterior body (also referred to as an exterior body film); although, a plurality of laminates are stacked and held in the space formed of the exterior body to increase the capacity of the secondary battery.

In addition, two lead electrodes 76 including sealing layers 75 illustrated in FIG. 12C are prepared. The lead electrodes 76 are each also referred to as a lead terminal or a tab and provided to lead a positive electrode or a negative electrode of the secondary battery to the outside of the exterior body. Aluminum and nickel-plated copper are used for a positive electrode lead and a negative electrode lead, respectively, of the lead electrodes 76.

Then, the positive electrode lead is electrically connected to a protruding portion of the positive electrode current collector 72 by ultrasonic welding. The negative electrode lead is electrically connected to a protruding portion of the negative electrode current collector 74 by ultrasonic welding.

Then, two sides of the exterior body 11 are subjected to thermocompression bonding by the above-described method and one side is left open for introduction of an electrolyte solution, whereby a bonding portion 33 is formed. After that, in reduced pressure or an inert atmosphere, a desired amount of electrolyte solution is dripped into the exterior body 11 having a bag-like shape. Lastly, the outer edge of the exterior body that has not been subjected to thermocompression bonding and is left open is subjected to thermocompression bonding, whereby a bonding portion 34 is formed. In thermocompression bonding, the sealing layers 75 provided over the lead electrodes are also melted, thereby fixing the lead electrodes and the exterior body 11 to each other.

In this manner, the secondary battery 10 illustrated in FIG. 12D can be fabricated.

### Embodiment 4

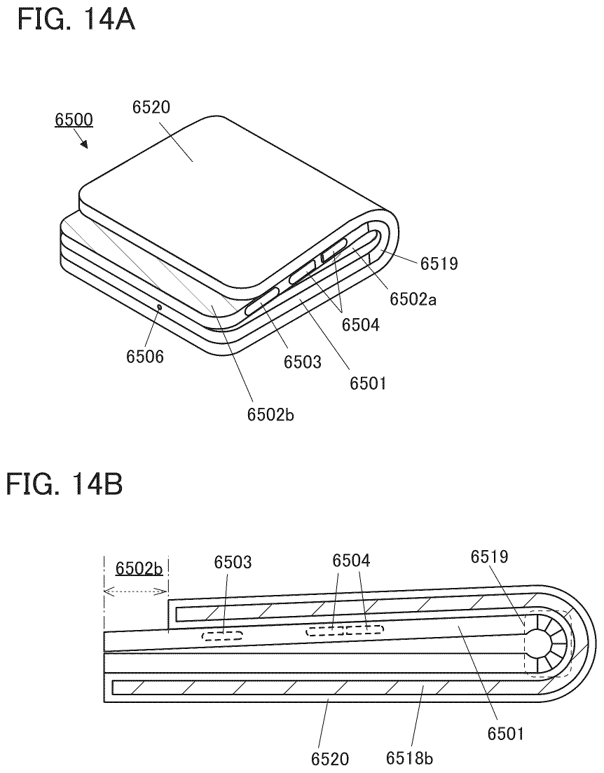

In this embodiment, electronic devices of one embodiment of the present invention will be described with reference to FIG. 13 and FIG. 14.

An electronic device 6500 illustrated in FIG. 13A is a portable information terminal that can be used as a smartphone.

The electronic device 6500 includes at least a housing 6501, a display portion 6502a, a power button 6503, buttons 6504, a speaker 6505, and a microphone 6506. The display portion 6502a has a touch panel function.

The electronic device 6500 can be folded at a hinge portion 6519. Accordingly, part of the display portion 6502a (the portion indicated by the dotted line in FIG. 13A) becomes a bent portion of the display portion 6502a, and the bent portion of the first battery 6518a or the second battery 6518b overlap with the bent portion of the display portion 6502a. In the case where one or both of the first battery 6518a and the second battery 6518b are bent, bending of the secondary battery can be controlled by the hinge portion 6519 in a range of the curvature radius of curvature from 10 mm to 60 mm.

FIG. 13B is a schematic cross-sectional view including an end portion of the housing 6501 on the microphone 6506 side.

A protection member 6510 having a light-transmitting property is provided on the display surface side of the housing 6501, and a display panel 6511, an optical member 6512, a touch sensor panel 6513, a printed circuit board 6517, and a first battery 6518a are provided in a space surrounded by the housing 6501 and the protection member 6510.

The display panel 6511, the optical member 6512, and the touch sensor panel 6513 are fixed to the protection member 6510 with an adhesive layer (not illustrated).

Part of the display panel 6511 is folded back in a region outside the display portion 6502a, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. The flexible display includes a plurality of flexible films and employs a plurality of light-emitting elements arranged in a matrix. As the light-emitting element, an EL element (also referred to as an EL device) typified by an OLED (Organic Light Emitting Diode) or a QLED (Quantum-dot Light Emitting Diode) is preferably used. Examples of a light-emitting substance contained in the EL element include a substance that emits fluorescent light (a fluorescent material), a substance that emits phosphorescent light (a phosphorescent material), an inorganic compound (e.g., a quantum dot material), and a substance exhibiting thermally activated delayed fluorescence (a thermally activated delayed fluorescent (TADF) material). An LED typified by a micro LED or a mini LED can also be used as the light-emitting element. Note that there is no particular limitation on the LED, and for example, a micro LED having a quantum well junction or a nanocolumn LED may be used. The area of a light-emitting region of the LED is preferably less than or equal to 1 mm², further preferably less than or equal to 10000 μm², still further preferably less than or equal to 3000 μm², even further preferably less than or equal to 700 μm². The area of the region is preferably greater than or equal to 1 μm², further preferably greater than or equal to 10 μm², still further preferably greater than or equal to 100 μm². Note that in this specification and the like, an LED chip with a light emission area of 10000 μm² or less is referred to as a micro LED in some cases. An LED having alight-emitting region whose area is larger than 10000 μm² is referred to as a mini LED in some cases. For example, a plurality of light-emitting diode chips is arranged at regular intervals over a flexible substrate to form one pixel region. An optical film may be provided additionally. For example, in the case where light-emitting elements that emit ultraviolet light is used as the light-emitting diode chips for the display portion, a full-color display can be achieved by providing a color conversion layer. The color conversion layer may be provided on the path of a light-emitting direction; in the case of two light-emitting directions, two color conversion layers (or color conversion films) are provided so that the light-emitting diode chips are interposed therebetween. The color conversion layer (or color conversion film) is preferably provided between the flexible substrate 810 and the resin because the alignment is important. Full-color display may be achieved by using a white-light-emitting diode chip and providing a color filter.

The use of the flexible display allows an internal space of the housing 6501 to be effectively utilized and an extremely lightweight electronic device to be achieved. Since the display panel 6511 is extremely thin, the first battery 6518a with high capacity can be mounted while the thickness of the electronic device is reduced.

Furthermore, in the electronic device 6500 using the high capacity battery, a second battery 6518b is provided inside a cover portion 6520 and is electrically connected to the first battery 6518a although the connection portion therebetween is not illustrated.

Part of the display panel 6511 is folded back such that a connection portion with the FPC 6515 is provided on the rear side of the pixel portion, whereby an electronic device with a narrow bezel can be achieved.

When the bendable secondary battery of one embodiment of the present invention is used as one or both of the first battery 6518a and the second battery 6518b, the electronic device 6500 can be partly folded to be downsized, so that the electronic device 6500 with high portability can be achieved.

FIG. 14A is a perspective view illustrating a folded state along the dotted line portion in FIG. 13A. The electronic device 6500 can be folded in two; the display portion 6502a and the second battery 6518b can be folded repeatedly.

FIG. 14A has a structure in which a second display portion 6502b is provided in a portion exposed when the cover portion 6520 slides by folding. Even when the cover portion 6520 is folded in two, a user can check simple time display or e-mail reception notification display by seen the second display portion 6502b.

FIG. 14B schematically illustrates a cross-sectional state of the cover portion in a state where the electronic device 6500 is folded. In FIG. 14B, the inside of the housing 6501 is not illustrated for simplicity.

In FIG. 14B, the hinge portion 6519 can be referred to as a connection portion and can have various modes as well as a structure example in which a plurality of columnar bodies are connected. It is particularly preferable that the hinge portion 6519 have a mechanism capable of folding the display portion 6502a and the second battery 6518b. The positions of the bent portions of the display portion 6502a and the second battery 6518b is determined by the hinge portion 6519, which might cause a problem of a decrease in reliability in the portion; however, the decrease in reliability can be prevented by applying the secondary battery described in embodiment 1 to the second battery 6518b.

Although one second battery 6518b is illustrated inside the cover portion 6520, a plurality of second batteries 6518b may be provided. In addition, a charging control circuit or a wireless charging circuit of the second battery 6518b may be provided inside the cover portion 6520.

In the example, the cover portion 6520 is partly fixed to the housing 6501 and is not fixed to a portion overlapping with the hinge portion 6519 and a portion overlapping with the second display portion 6502b that is exposed when the cover portion 6520 slides by folding.

The cover portion 6520 is not necessarily fixed to the housing 6501 and may be detachable. In the case where high capacity is not needed, the electronic device 6500 can be used while the cover portion 6520 is detached and the first battery 6518a is used. Charge of the detached second battery 6518b allows supplementary charge of the first battery 6518a when the second battery 6518b is reconnected to the first battery 6518a. Thus, the cover portion 6520 can also be used as a mobile battery.

FIG. 14A and FIG. 14B illustrate an example in which the display portion 6502a is folded in two such that the display surface faces inside; however, there is no particular limitation and the hinge portion 6519 may have a structure allowing the display portion 6502a to be folded in two such that the display surface faces outside. In the secondary battery of one embodiment of the present invention, a lithium metal film is used as the negative electrode; whereby a variation in potential can be reduced even when the secondary battery is charged and discharged in a state of being folded in two, that is, in the state of being bent.

The secondary battery of one embodiment of the present invention has high reliability with respect to repetitive deformation, and thus can be suitably used for a device that can be folded in the above-described manner (also referred to as a foldable device).

At least part of this embodiment can be implemented in combination with the other embodiments described in this specification as appropriate.

### Embodiment 5

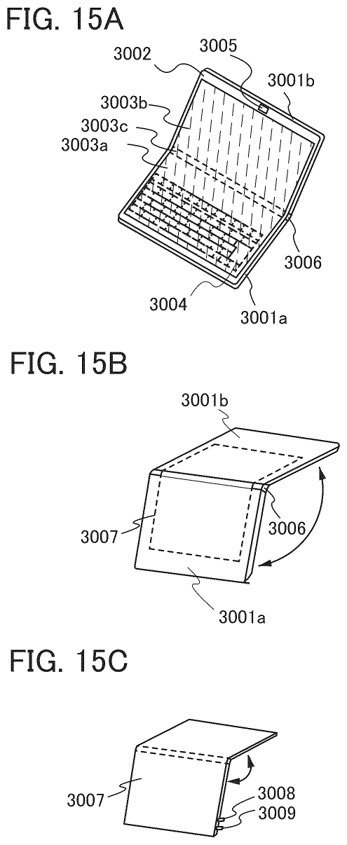

Although a smartphone is shown as an example in Embodiment 4, one embodiment of the present invention is not limited thereto. An electronic device of one embodiment of the present invention is described with reference to FIG. 15.

FIG. 15A illustrates a foldable personal computer or a foldable tablet fabricated by mounting the secondary battery disclosed in this specification as at least one component, and illustrates an example of the appearance.

In FIG. 15A, a first housing 3001a, a second housing 3001b, and a hinge portion 3006 between the first housing 3001a and the second housing 3001b are provided, and the device is folded in a region shown by the dotted lines in the drawing and can be opened and closed. A peripheral portion 3002 is protected using a rubber member that surrounds the periphery of a display portion.

The rubber member of the peripheral portion 3002 includes openings: an opening of the display portion and an opening of a sensor portion 3005. An optical system including a lens and an imaging element are provided in the sensor portion 3005, and an image of a user can be captured. As the imaging element, a CCD camera or a CMOS camera can be used, for example. In addition, an infrared camera may be used in combination with such a camera. The infrared camera, which has a higher output level with a higher temperature of an object, can sense or extract a living body such as a human or an animal. A distance image sensor may be provided as the imaging element, which can also be used as a biometric authentication sensor by capturing an image of the user.

When the user opens or closes the device by changing a distance between the first housing 3001a and the second housing 3001b, the device is folded in the portion shown by the dotted lines in the drawing; thus, in the case where the display portion is used as one display region, the display portion is preferably formed using a plurality of flexible films. Note that the film is not limited to an organic material and may be a thin glass substrate having flexibility, for example.

The display portion is formed using a plurality of flexible films and uses a plurality of light-emitting elements arranged in a matrix.

As the light-emitting element, an EL element (also referred to as an EL device) typified by an OLED or a QLED is preferably used. Examples of a light-emitting substance contained in the EL element include a substance exhibiting fluorescence (a fluorescent material), a substance exhibiting phosphorescence (a phosphorescent material), an inorganic compound (a quantum dot material), and a substance exhibiting thermally activated delayed fluorescence (a thermally activated delayed fluorescence (TADF) material). An LED typified by a micro LED can also be used as the light-emitting element.

The display portion can be divided into three display regions: a display region 3003a overlapping with the first housing 3001a, a display region 3003b overlapping with the second housing 3001b, and a display region 3003c overlapping with the hinge portion 3006.

The display portion may have a touch input function, and FIG. 15A illustrates an example in which display buttons 3004 of a keyboard are displayed.

When a light-receiving element is used as a touch sensor, touch operation of an object can be detected using the light-receiving element.

Alternatively, both a light-emitting element and a light-receiving element may be provided in the display portion, and an image can be captured using the light-receiving element. For example, the light-receiving element can be used as an image sensor. Data on biological information typified by a fingerprint or a palm print can be obtained by using the function of the image sensor. That is, a biometric authentication sensor can be incorporated in the display portion. When the display portion incorporates a biometric authentication sensor, the number of components of an electronic device can be reduced as compared to the case where a biometric authentication sensor is provided separately from the display portion; thus, the size and weight of the electronic device can be reduced. In the case where the display portion includes a biometric authentication sensor, the sensor portion 3005 illustrated in FIG. 15A is not necessarily provided.

As the light-receiving element, a pn photodiode or a pin photodiode can be used, for example. The light-receiving element functions as a photoelectric conversion element (also referred to as a photoelectric conversion device) that detects light entering the light-receiving element and generates electric charge. The amount of electric charge generated from the light-receiving element depends on the amount of light entering the light-receiving element.

It is particularly preferable to use an organic photodiode including a layer containing an organic compound as the light-receiving element. An organic photodiode, which is easily made thin, lightweight, and large in area and has a high degree of freedom for shape and design, can be used in a variety of devices.

FIG. 15A is an external view seen from the side where the display portion is provided, and FIG. 15B is an external view seen from a point of view different from that in FIG. 15A.

In FIG. 15B, a secondary battery 3007 incorporated in the first housing 3001a and the second housing 3001b is shown by the dotted line.

The secondary battery 3007 is incorporated in both the first housing 3001a and the second housing 3001b, whereby the secondary battery with higher capacity can be provided.

FIG. 15C illustrates an example of the appearance of the incorporated flexible secondary battery 3007. In this embodiment, the flexible secondary battery 3007 that can be bent at least partly, specifically capable of being bent with a region indicated by a dotted lines as an bent portion, is used. The bent portion of the secondary battery 3007 overlaps with the display region 3003b that is part of the display portion.

As the flexible secondary battery 3007, a bendable battery described in Embodiment 1 (a battery having a structure in which a lithium metal film is used as a negative electrode and current collectors slide) can be used. In the secondary battery of one embodiment of the present invention, a lithium metal film is used as the negative electrode; whereby a variation in potential can be reduced even when the secondary battery is charged and discharged in a state of being folded in two, that is, in the state of being bent. The flexible secondary battery 3007 is fabricated by the fabrication method of the laminated secondary battery illustrated in FIG. 12, and includes the tab portions 3008 and 3009 for being electrically connected with the control circuit portion of the secondary battery.

The flexible secondary battery can be used not only for the folding personal computer or the folding tablet described in this embodiment, but also for a secondary battery for vehicles typified by hybrid electric vehicles (HVs), electric vehicles (EVs), and plug-in hybrid electric vehicles (PHVs), for example. The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be provided regardless of location; a bendable secondary battery can be provided according to the space where the secondary battery is incorporated. For example, in the case where a solar cell panel provided in an artificial satellite has a folding structure, a bendable battery described in Embodiment 1 can be used in a folding portion.

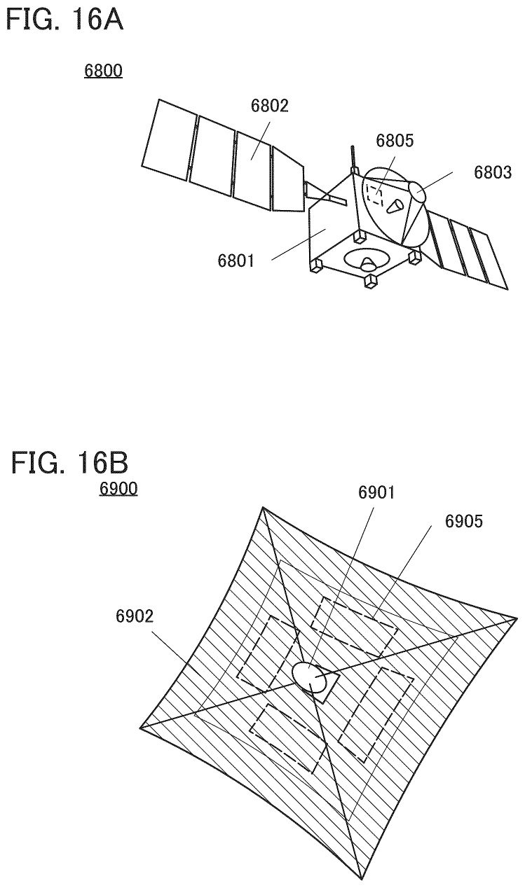

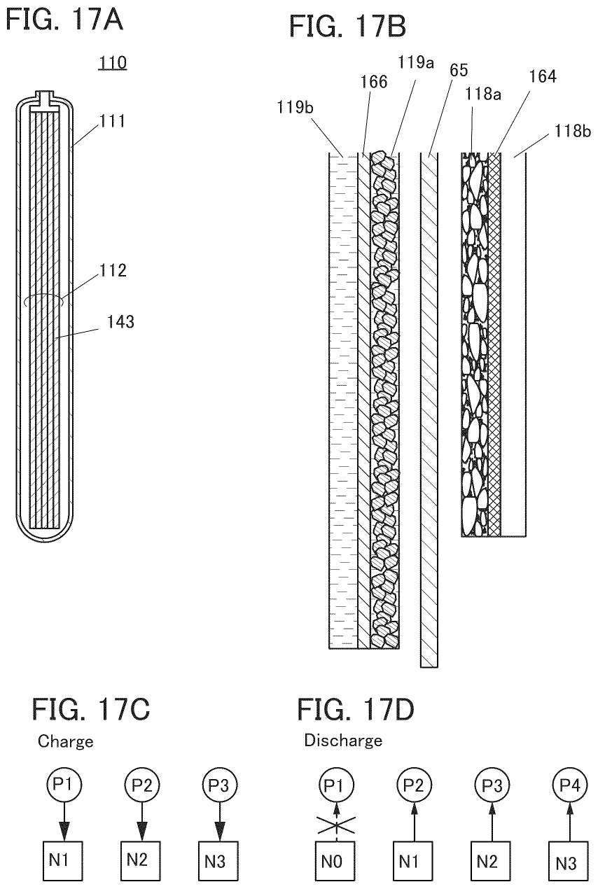

FIG. 16A illustrates an artificial satellite 6800 as an example of a device for space. The artificial satellite 6800 includes a body 6801, a solar panel 6802, an antenna 6803, and a secondary battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

FIG. 16B illustrates a probe 6900 including a solar sail as an example of a device for space. The probe 6900 includes a body 6901, a solar sail 6902, and a secondary battery 6905. When photons from the sun are incident on the surface of the solar sail 6902, the momentum is transmitted to the solar sail 6902. Therefore, it is preferable that the surface of the solar sail 6902 have a thin film with high reflectance, and it is further preferable that the surface of the solar sail 6902 face the sun.

In addition, the solar sail 6902 is in a folded-up state until it goes outside the atmosphere, and it is opened into a large sheet-like shape at outside the atmosphere (space) as illustrated in FIG. 16B. Therefore, the bendable secondary battery of one embodiment of the present invention is preferably used as the secondary battery 6905 mounted on the solar sail 6902.

This embodiment can be freely combined with the other embodiments.

### REFERENCE NUMERALS

10: secondary battery, 11: exterior body, 12: laminated body, 13a: lead electrode, 13b: lead electrode, 18: positive electrode active material layer, 19a: negative electrode active material layer, 19b: negative electrode active material layer, 21: crest line, 22: trough line, 25: space, 31a: portion, 31b: portion, 31: portion, 32: folding portion, 33: bonding portion, 34: bonding portion, 43: electrode, 61: film, 62: film, 63: film, 64a: positive electrode current collector, 64b: positive electrode current collector, 64c: positive electrode current collector, 64d: positive electrode current collector, 65: separator, 66a: negative electrode current collector, 66b: negative electrode current collector, 66c: negative electrode current collector, 66d: negative electrode current collector, 72: positive electrode current collector, 73: separator, 74: negative electrode current collector, 75: sealing layer, 76: lead electrode, 100: positive electrode active material, 110: secondary battery, 111: exterior body, 112: laminated body, 118a: positive electrode active material layer, 118b: positive electrode active material layer, 119a: negative electrode active material layer, 119b: negative electrode active material layer, 143: electrode, 164: positive electrode current collector, 166: negative electrode current collector, 170: coprecipitation synthesis apparatus, 171: reaction vessel, 172: stirrer, 173: stirring motor, 175: tank, 176: tube, 177: pump, 180: tank, 181: tube, 182: pump, 186: tank, 187: tube, 188: pump, 190: control device, 192: aqueous solution, 200A: positive electrode active material, 810: substrate, 890: aqueous solution, 892: aqueous solution, 893: aqueous solution, 894: aqueous solution, 901: mixed solution, 902: mixed solution, 903: mixture, 904: mixture, 905: mixture, 3001a: first housing, 3001b: second housing, 3002: peripheral portion, 3003a: display region, 3003b: display region, 3003c: display region, 3004: display button, 3005: sensor portion, 3006: hinge portion, 3007: secondary battery, 3008: tab portion, 3009: tab portion, 6500: electronic device, 6501: housing, 6502a: display portion, 6502b: second display portion, 6503: power button, 6504: button, 6505: speaker, 6506: microphone, 6510: protection member, 6511: display panel, 6512: optical member, 6513: touch sensor panel, 6515: FPC, 6516: IC, 6517: printed circuit board, 6518a: first battery, 6518b: second battery, 6519: hinge portion, 6520: cover portion, 6800: artificial satellite, 6801: body, 6802: solar panel, 6803: antenna, 6805: secondary battery, 6900: probe, 6901: body, 6902: solar sail, 6905: secondary battery

1. A secondary battery comprising:
a laminated body comprising a positive electrode current collector, a separator, and a negative electrode current collector surrounded by an exterior body,
wherein the secondary battery comprises a bent portion capable of being bent,
wherein a positive electrode active material layer is provided over the positive electrode current collector,
wherein a negative electrode active material layer is provided over the negative electrode current collector, and
wherein the negative electrode active material layer comprises a lithium film.

2. The secondary battery according to claim 1, wherein the negative electrode active material layer is formed by an evaporation method or a sputtering method.

3. The secondary battery according to claim 1, wherein the exterior body is an embossed film comprising parallel grooves or intersecting grooves.

4. The secondary battery according to claim 1,
wherein the laminated body comprises a stack of a first negative electrode current collector and a second negative electrode current collector in contact with the first negative electrode current collector.

5. The secondary battery according to claim 1,
wherein the lithium film has a thickness greater than or equal to 100 nm and less than or equal to 10 μm.

6. The secondary battery according to claim 1,
wherein the positive electrode active material layer comprises lithium cobalt oxide with a median diameter of less than or equal to 10 μm.

7. The secondary battery according to claim 1,
wherein the positive electrode active material layer comprises a positive electrode active material particle comprising nickel, cobalt, and manganese.

8. An electronic device comprising:
the secondary battery according to claim 1.
